(19) United States
(12) Patent Application Publication
(10) Pub. No.: US 2007/0130585 A1
(43) Pub. Date: Jun. 7, 2007

(54) Virtual Store Management Method and System for Operating an Interactive Audio/Video Entertainment System According to Viewers Tastes and Preferences

(76) Inventors: Pierre Andre Perret, Glendale, AZ (US); Mark A. Pearson, (US)

Correspondence Address: RUSSELL W. BURGE, 21140 COVINA HILLS ROAD, COVINA, CA, 91724, US

(21) Appl. No.: 11/562,984

(22) Filed: Nov. 23, 2006

Related U.S. Application Data
(60) Provisional application No. 60/742,303, filed on Dec. 5, 2005.

(51) Int. Cl. H04N 7/173; H04N 5/445; H04N 7/025; H04N 7/10; G06F 3/00; G06F 13/00

(52) U.S. Cl. 725/46; 725/34; 725/35; 725/86; 725/45

(57) ABSTRACT

This invention confers to an interactive audio/video entertainment system providing video-on-demand (VOD) services the abilities to automatically adapt to viewers tastes and preferences and download in advance the most likely viewing choices of each user, thereby freeing the system and its users from the real-time throughput constraints and availability limitations of the audio/video distribution network. Viewers are presented with a virtual video-rental-store paradigm offering a locally stored, and therefore immediately available for rental, selection of audio/video programs tailored to each viewer on the basis of observation by the system, in a transparent fashion, of the viewer's past choices.

### CROSS REFERENCE TO RELATED APPLICATIONS

This application claims priority from our provisional patent application entitled “Virtual Store Management Method for Operating an Interactive Audio/Video Entertainment System According to Viewers Tastes and Preferences”, filed Dec. 5, 2005, with Ser. No. 60/742,303.

### FIELD OF THE INVENTION

This invention relates to interactive audio/video entertainment systems, such as interactive television systems, and more specifically to methods and apparatus for operating such interactive audio/video entertainment systems in ways that facilitate rental of digitally encoded motion pictures.

### BACKGROUND OF THE INVENTION

Movie audiences are familiar with buying or renting audio/video entertainment in the form of physical media, specifically digital video disks (DVD) or videotape cassettes (VHS), by visiting “brick and mortar” physical video stores or by ordering from mail order companies.

Newer, interactive television systems (“ITV”) are now bringing an approximation of the video store's rental experience to people's homes via digital communication channels such as the ubiquitous computer communication network know as the “Internet” or other, more specialized, entertainment distribution methods, e.g. digital cable-TV, telephone line-based Digital Subscriber Line (“DSL”), and digital satellite-TV. These systems often provide traditional forms of programming, such as familiar “cable” or local broadcast audio/video programs that may include segments destined to the general public, segments enabled for specific subscribers only, and segments enabled on a pay-per-view (“PPV”) basis. ITV systems also provide newer forms of programming to the users' homes, such as video-on-demand (“VOD”) services, which have been offered in some hotel television systems for several years. VOD services allow a user to select and order a program to view directly from his/her television set, typically using a handheld remote control unit to navigate on-screen menus and input his/her choices. Compared to PPV, where the user pays a fee to access a particular broadcast channel during the time period corresponding to a particular program transmission, modern VOD services provide the user with more control of the viewing experience: the program can be started at any time of the user's convenience, playback can be paused then resumed at a later time, and in many cases playback can be finely controlled by the user in a manner similar to that experienced with a DVD or VHS player, for instance allowing slow-motion playback, fast-forwarding, backwards (“rewind”) playback, and skipping back and forth to sections or chapters within the program. VOD services are typically available on either a pay-per-play basis or a subscription basis and are thus very similar, from the user's perspective, to the rental of physical media (DVD or VHS) with the added convenience that no travel to a store or waiting for postal delivery is involved and that VOD program rentals never run out-of-stock since they are not limited to any particular number of physical copies.

Recently emerging Internet-based VOD services have the potential to supplant the more traditional audio/video entertainment distribution architectures: cable-TV, DSL-TV, and satellite-TV that all have very high initial deployment costs that preclude all but very large corporate entities from offering such services. Satellite-TV systems do not suffer from the geographical limitations of hard-wired systems such as cable-TV or DSL, but they generally only offer one-way communication channels (from provider to user), do not have a natural communication path from user to provider, and are therefore hard-pressed to provide the same level of VOD capabilities as the other systems. In contrast to cable-TV or DSL-TV systems, Internet-based VOD services can enjoy distribution in widely dispersed geographical areas, as they are not bound to the service area of any specific communication medium provider; they may include the capability to address mobile systems and naturally provide two-way communications between user devices and service provider systems. In addition, the ubiquitous availability of many Internet-based VOD service providers has the advantage of allowing any user a wide choice of entertainment sources (as opposed to the regional monopolies of the traditional architectures), thus fostering competition and the consequent improvement of services and innovation on the part of those providers.

VOD services operate with a set-top-box (so called because it is typically placed near or atop the user's television set), or “STB”, located in each user's premises, coupled to the user's entertainment center for the transmission of audio and video signals, and connected via Internet (or, possibly, cable-TV, DSL, or satellite-TV media) to VOD service provider systems. In some cases the STB is not a physical independent device; instead, its functions are embodied as software into a generic personal computer that is similarly coupled to the entertainment center. In the case of a mobile audio/video entertainment device (e.g. handheld) the STB functions may also be integrated into the device.

VOD services can be divided into two species: streaming and download. In a streaming VOD context, the STB receives a digitally encoded audio/video stream from one of a plurality of server systems (often called “headends”) that each serves a limited number of users. Each STB has a relatively small amount of buffer memory in which a few seconds of incoming stream can be stored ahead of rendering, enabling it to minimize the impact on the user experience of minor communications disruptions (such as transmission errors, delays or short connectivity loss). Streamed data is sent to the STB in real-time at a predetermined data rate that must be well within the capability (in term of bandwidth) of the communication medium or network between headend and STB. The STB can begin rendering as soon as it has stored a few seconds of content in memory and it typically does not save that data for the long term. Changes requested by the user in the sequencing of the program (such as rewind, fastforward, etc. . . . ) are handled by the STB relaying those requests to the headend and by the headend, in response, modifying its output towards that STB to issue an appropriate stream yielding the desired audio/video result.

In a download VOD context, each STB is equipped with enough digital mass storage capacity (typically in the form of a non-removable magnetic disk media) to locally keep a complete copy of at least one full-length movie feature for the long term, or at least the time period during which the user is entitled to enjoy that particular program. The data is downloaded and stored within the STB as it is received from server systems (called “headends” in that case as well) and playback starts, at the earliest, after the download has finished. Since there is no reliance on real-time communications, communication disruptions and bandwidth limitations are not critical factors: they just increase the delay until playback is available. Changes requested by the user in the sequencing of the playback (such as rewind, fastforward, etc. . . . ) are handled internally by the STB without any need to interact with the server systems.

It is also possible to combine the streaming and download VOD approaches into a hybrid one called “progressive download” where playback does not wait until the full download has finished. Instead, the playback may start earlier, as soon as enough data has arrived to allow uninterrupted playback while the rest of the program is being received. The delay before start of playback depends on the data rate and the expected average available bandwidth. In this mode, fast forward capability is curtailed and playback can be affected by communication disruptions, albeit generally to a lesser extent than with pure streaming.

For a given compression algorithm, the audio/video quality experienced by a user is determined by the average data rate of the digitally encoded audio/video stream, usually expressed in kilobits per seconds (kbps). With the most recent high-efficiency audio and video compression methods, a DVD-quality audio and video experience suitable for a home theater with surround sound can be obtained with a data rate of about 1000 kbps and a VHS-like experience with stereo sound, acceptable for a handheld portable device, can be obtained with a data rate of about 250 kbps. For a program length of 133 minutes (a reasonable duration for a theatrical movie), the total sizes of the corresponding digitally encoded audio/video streams would be, respectively, 1 gigabyte and 250 megabytes.

In a streaming VOD context, audio/video quality is bounded by the bandwidth available between headend and STB. In a download context, audio/video quality is limited by both the storage space available for a single program in the STB (generally not a significant constraint, except possibly on mobile handheld systems) and the need to keep the download delay at a level acceptable to the user. In the case of Internet-based VOD services, the typical useable bandwidth roughly ranges from 500 kbps to 3000 kbps. Therefore, streaming cannot provide full DVD-quality experience to all users and with download, many of the users expecting that level of quality must cope with a delay between ordering a program and enjoying it on the order of 4 hours. In the case of high definition video (“HDTV”), which requires a data rate roughly 6 times larger than the DVD-quality one, Internet-based distribution is well out of range for most users in streaming mode and downloads suffer a 6 fold increase in delays.

Current Internet-based VOD services have, so far, failed to live up to expectations as a pervasive entertainment distribution medium. As far as consumers are concerned, the compelling advantage of the VOD concept resides in the immediate gratification it promises, compared to its alternatives: rental of physical media (e.g. a DVD), which involves waiting for mail delivery or physically visiting a store, or traditional television programming, which involves being dependent on broadcast schedules or planning the recording of a show beforehand. Optimally, a user should be able to browse a VOD service's extensive catalog from the comfort of his/her home (or, in the case of a mobile entertainment device, wherever the user is), pick a movie that he/she feels like watching and start enjoying the playback thereof immediately. The service must be able to provide uninterrupted playback with a quality commensurate with that provided by the alternatives (analog or digital television broadcast, VHS, DVD, and in the near future, HDTV). Such an optimal VOD service would not only satisfy it users, but also increase the amount of rental business realized by the audio/video content providers by virtue of the easy, spur-of-the-moment, access to entertainment it provides for consumers.

Insufficient Internet bandwidth and sometimes unreliable connectivity (particularly in the mobile case) at the user end hobble the current Internet-based VOD providers who have no control over these limitations and are therefore forced to either compromise audio/video quality in order to reduce the data rate for streaming or delay user satisfaction (thus defeating the very purpose of VOD) by having to rely on the download approach to deliver acceptable quality.

In addition, any Internet VOD service has to contend with the congestion (which lowers both connection speed and reliability) that is most likely to occur at the very time most users would make use of the service. This so-called “prime-time” is the period of the day when people are most likely to seek audio/video entertainment and roughly lasts 5 hours, from 6 pm to 11 pm. During the same period, non-VOD Internet traffic from homes also peaks. Since a finite amount of available Internet bandwidth within a neighborhood is typically distributed among the homes in that area due to the sharing of a common transmission medium (cable, wireless spectrum) and/or the sharing of common infrastructure equipment (phone exchange access multiplexer, Internet provider routers), the bandwidth available to each home is generally lower during prime-time than during periods of lesser global usage.

The prime-time rush also causes VOD service providers extra costs, as their distribution infrastructure (headends or other servers, as well as the corresponding Internet connectivity) need to be dimensioned to support the corresponding peak demand instead of a much lower daily average throughput.

### BRIEF SUMMARY OF THE INVENTION

This invention confers to an interactive audio/video entertainment system providing video-on-demand (VOD) services the abilities to automatically adapt to viewers tastes and preferences and download in advance the most likely viewing choices of each user, thereby freeing the system and its users from the real-time throughput constraints and availability limitations of the audio/video distribution network. Viewers are presented with a virtual video-rental-store paradigm offering a locally stored, and therefore immediately available for rental, selection of audio/video programs tailored to each viewer on the basis of observation by the system, in a transparent fashion, of the viewer's past choices.

### BRIEF DESCRIPTION OF THE DRAWINGS

The present invention is illustrated by way of example, and not by way of limitation, in the figures of the accompanying drawings and in which:

FIG. 1 is a conceptual diagram of an interactive audio/video entertainment network according to this invention;

FIG. 2 is a block diagram of a VOD set-top-box (STB) unit, labeled 3 in FIG. 1, which includes a virtual store management subsystem that embodies this invention;

FIG. 3 is a block diagram of the high-level functional elements that compose the virtual store management subsystem;

FIG. 4 is a simplified example of a database record used to supply the system with information about an audio/video entertainment program;

FIG. 5 is a simplified example of a database record used to represent an event in the history of user behavior gathered by the system;

FIG. 6 is a simplified example of a database record used to represent a movie that is available for rental by users in an audio/video entertainment system that includes an embodiment of this invention;

FIG. 7 is a block diagram of the virtual store management subsystem's qualifier component that is labeled 28 in FIG. 3;

FIG. 8 is a flow diagram of the steps executed by the training samples composer subtask that is labeled 53 in FIG. 7;

FIG. 9 is a mapping diagram showing the assignment of a multiplier factor to an appraisal;

FIG. 10 is a data structure diagram showing the contents of a training sample;

FIG. 11 is a flow diagram of the steps executed by the procedure to merge an appraisal into a training sample;

FIG. 12 is a flow diagram of the steps executed by the grading-and-sorting subtask that is labeled 55 in FIG. 7;

FIG. 13 is a flow diagram of the steps executed by the procedure to compute a grade;

FIG. 14 is a flow diagram of the steps executed by the procedure to compute a score;

FIG. 15 is a flow diagram of the steps executed by the list-balancing subtask that is labeled 57 in FIG. 7;

FIG. 16 is a block diagram of the virtual store management subsystem's inventory manager component that is labeled 30 in FIG. 3;

FIG. 17 is a flow diagram of the steps executed by the prioritizing subtask that is labeled 111 in FIG. 16;

FIG. 18 is a flow diagram of the steps executed by the download subtask that is labeled 112 in FIG. 16;

FIG. 19 is a flow diagram of the steps executed by the provider-polling subtask that is labeled 113 in FIG. 16; and

FIG. 20 is a block diagram of the interactions between the elements that compose the virtual store management subsystem and the other STB subsystems.

### DETAILED DESCRIPTION OF THE INVENTION

The present invention provides an interactive audio/video entertainment system with a VOD service that delivers instant gratification to its users, by presenting them with a virtual video-rental-store paradigm that allows immediate viewing of any movie within the virtual store's inventory. The virtual store automatically and transparently (i.e. without user involvement) optimizes its inventory to tailor it to the users' tastes so that movies from the VOD service's catalog that are the most likely to be desired by a particular user are automatically downloaded in advance into that user's STB. Given the large size of current affordable mass storage media, a STB can stock upwards of 200 movies of DVD-equivalent quality (in the near future, by the time high definition DVD-like media becomes widely accepted as a rental item in the marketplace, expected increases of affordable mass storage capacity will provide the capability to stock similar quantities of HD quality movies). The bandwidth and connectivity issues encountered by prior art VOD systems and described above are rendered moot by this invention since, at any time a user contemplates watching audio/video entertainment, many highly desirable programs are already at hand.

Each STB constantly learns its user's tastes and preferences in movies by observing the user's interactions with the entertainment system. Unlike the movie-recommendation algorithms used for the purpose of facilitating catalog browsing in some prior art VOD services, this invention's learning mechanisms do not require that users submit to the chores of supplying preference criteria (such as movie genres, or favorite actors) or bother with assigning explicit ratings to the movies they have viewed. In this invention, the underlying workings of the system are transparent and of no concern to the users, just like the inner workings of inventory management in a real video-rental-store would be.

As would be possible with a real video-rental-store, a user can issue a special-order for any movie (from the VOD service's catalog) that is not stocked in the virtual store at that time. This allows users to manifest, without commitment, intent to later rent the concerned movie when it becomes available as part of the virtual video-rental-store's inventory. In a typical setting, the system can arrange for the designated movie to become available for viewing within half a day, providing a service that is much better than what a real video-rental-store or mail order service could provide in the same situation.

An advantage of the present invention is that it utilizes client-side profiling of user preferences to determine what content to download to the user's system. The predictive prior art typically utilizes server-side collaborative filtering to determine what content to send to a user's client-side system. Thus, in the present invention, the determination of what content to download is made locally, in the client system, whether that is a set-top box, personal computer, entertainment system, etc., whereas in the prior art, it is made in a centralized server. The result is that in a system with server-side profiling, content is pushed from a server to a client system, whereas in the present invention, with client-side profiling, content is pulled from a server to the client system. This provides a number of advantages, including that predictive downloads can be closely tailored to a given user's needs and wants, and that the content stored on the client system can be better managed, all resulting in an enhanced viewing experience. In addition, client side control of content facilitates peer-to-peer exchanges between peer client-side systems, providing for significant advantages in scaling and performance.

With this invention, the scheduling of downloads is much more flexible than in prior art systems where data transfers occur only as direct consequences of users' requests or at the behest of a provider. In particular, this flexibility allows the STB to cope with relatively slow or erratic Internet access and even withstand lengthy (multiple hours) loss of connectivity without noticeable effects for the users (e.g. downloads can be interrupted and resumed later without the users being aware of those events). This freedom for the VOD service's systems to manage download schedules, unlike prior art systems, allows them to optimize distribution while still maximizing user satisfaction. For instance, the STB and download servers can collaborate to spread the data transfer load away from the overloaded prime-time period, thereby reducing the providers' infrastructure costs. The STB can also afford to throttle its data transfers in order to consume only a part of its users' total Internet bandwidth, thereby reducing the intrusiveness of the VOD service upon possible other Internet activities (e.g. “Web” browsing) in the users' home.

Further advantages will become apparent from a consideration of the ensuing description and drawings.

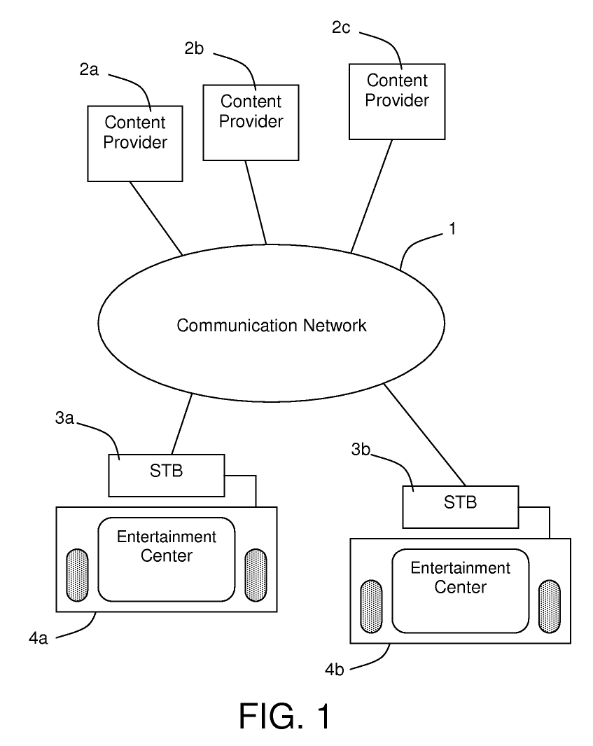

FIG. 1 shows an interactive audio/video entertainment system arrayed around a global communication network 1 through which a plurality of content provider systems (represented here by three instances: 2a, 2b, and 2c) are able to supply audio/video entertainment to a plurality of user homes, represented here by two instances of the concerned electronic equipment with, in each instance, a set-top box (3a or 3b) connected to an entertainment center (4a or 4b).

In the present invention's preferred embodiment, global communication network 1 consists of the worldwide Internet to which both the content provider systems and the set-top boxes have access through a variety of connection means. This involves intermediate components such as cabling, radio transmissions, switches and routers that are not directly relevant to the invention and are not expanded upon herein as they constitute generic elements of access to the Internet for a home user or a content provider system. In essence, the interactive audio/video entertainment system described herein does not in itself impose specific requirements on the communication network as it simply benefits from the infrastructure already in place for broadband Internet access.

The set of content provider systems (hereafter globally labeled 2) constitutes the repository that provides the audio/video content rented by users, such as theatrical movies or TV show episodes, hereafter generically referred to as “movies”. The content provider systems are owned by potentially separate business entities (such as movie aggregation/distribution companies or TV/movie studios). Each of these systems features a catalog (list) of its available movies as well as all of the data constituting the digitally encoded audio/video streams required to playback each of the movies mentioned in the catalog. In case digital rights management methods (e.g. encryption/decryption of copy-protected content) are used, some content provider systems are also responsible for providing, on an as-warranted movie-by-movie basis, the required cryptographic keys or certificates that authorize legitimate viewing.

Each set-top box (3a/3b) acts as a user interface unit and thus constitutes the intermediary between its users and the content provider systems for the purpose of movie rental. It typically includes a handheld remote control unit (not represented in the drawing for the sake of simplicity) similar to the remote control units commonly associated to Video Cassette Recorders or DVD players. The set-top box downloads catalog information from the set of content provider systems and elects to download and store locally a subset of the available digitally encoded audio/video streams. That locally stored subset is tailored to the tastes and preferences of the users and constitutes the set of movies that are available for immediate rental through the set-top box. Thus, in each home, the users are presented with a virtual video-rental-store paradigm where the “in-stock” movies can be rented out and instantly viewed. The typical stock size for this virtual video-rental-store is on the order of a hundred to two hundred movies. Since these “in-stock” movies are selected carefully by the set-top box to be the most likely to satisfy its users, the perceived availability of desirable entertainment material is actually equivalent to what would be offered in a physical store affording a much larger generic stock. In addition, the users can request that some specific movies of their choice be brought in (similarly to the special-ordering of a movie in a physical video store). Special-ordered movies are not immediately available for rental, but the set-top box schedules the download of the associated digitally encoded audio/video streams so that they appear as “in-stock” in the near future. The speed of that delivery depends largely on the download throughput capabilities of the home's Internet access; in the best cases, a special-order may be fulfilled in under an hour whereas in worst cases, there may be a delay of a couple of days.

Each entertainment center (4a/4b) may consist of an assembly of many separate elements (for instance a set of other entertainment sources such as CD/DVD player, video cassette player/recorder, and satellite/cable radio/TV tuner, all coupled to an audio/video amplifier feeding into a video monitor and a set of speakers) or, in its simplest expression, it may just be a television set. In any case, a user whishing to view a movie from the virtual rental-store service sets up the entertainment center to accept audio/video input from the set-top box and uses the associated handheld remote control unit to select, through on-screen menus managed by the set-top box, the movie to be played back.

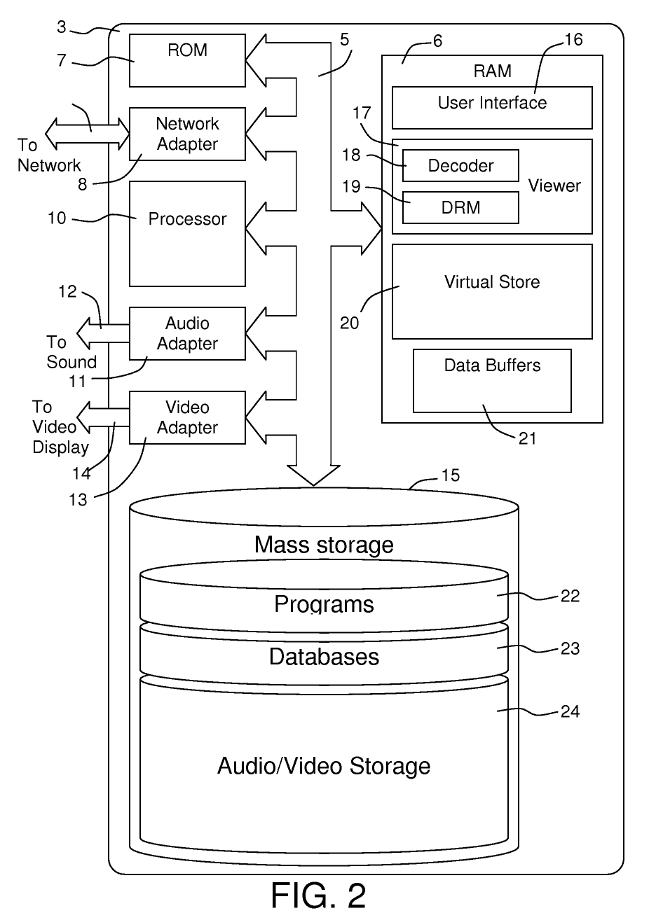

FIG. 2 shows a set-top-box 3 (STB) that implements the virtual video-rental-store functionality of the present invention. It is either a separate unit that interconnects with other elements of the home entertainment center (audio amplifier, audio/video receiver, video monitor, or television set) or an internal part integrated within one of the home entertainment elements. The components of the STB interact with one another via an internal bus 5. They include a volatile memory (RAM) 6, a non-volatile memory (ROM) 7, a network adapter 8 that controls a network interface 9, a processor 10, an audio adapter 11 that controls an audio interface 12, a video adapter 13 that controls a video interface 14, and a mass storage device 15. While the STB is operating, RAM 6 contains programs (executable by processor 10) that control the operation of the STB and are referred herein as its subsystems. Those programs include a user-interface subsystem 16, a viewer subsystem 17 that comprises a decoder subprogram 18 and a digital right management (“DRM”) subprogram 19, and a virtual store management subsystem 20. RAM 6 also contains a set of data buffers 21 used by the above subsystems to store temporary data. Mass storage device 15 contains a set of program files 22, a set of databases 23, and an audio/video storage 24.

Internal bus 5 is typically a multi-bit parallel conductor that interconnects all the STB components. It carries clocking signals, addressing information, and data, thus allowing the components to communicate with one another. For instance, processor 10 uses the internal bus to address locations in RAM 6 where it fetches program instructions or reads/writes data. Likewise, network adapter 8 receives commands from the processor and sends back acknowledgments via the internal bus; the network adapter also transfers data, corresponding to network data received or sent through network interface 9, to and from the RAM via the internal bus.

RAM 6 is an assembly of volatile electronic digital memory and associated control circuitry that can store programming information as well as data to be read and written by the other components of the STB via the internal bus. The RAM is designated as “volatile” because its content may be lost whenever electric power ceases to be supplied. A current typical practical capacity for the RAM is 64 megabytes although that figure may vary among various implementations of the STB, mostly depending on memory chips availability and cost constraints.

ROM 7 is an assembly of non-volatile electronic digital memory and associated control circuitry that contains pre-written programming information as well as data to be read by processor 10 via the internal bus during the startup (after reset or powering up) of the STB to provide minimal instructions for self test and transfer of further programs (subsystems) into the RAM from mass storage device 15. The ROM is designated as “non-volatile” because its content are preserved even when electric power is not supplied. For ease of maintenance of the STB, all or part of the ROM may be constituted of electronically erasable and rewritable memory (e.g. EEPROM). A typical practical capacity for the ROM is currently 512 kilobytes.

Network adapter 8 manages the reception and transmission of data packets over network interface 9. The data flowing through the network interface is mainly data exchanged with set of content provider systems 2, constituting audio/video content (digitally encoded movies), lists of available movies, and cryptographic keys and certificates. In addition, the network interface may be used for ancillary purposes, such as exchange of billing information and remote maintenance communications. In this invention's preferred embodiment, network interface 9 implements communication via the Internet family of protocols over either wired Ethernet (e.g. 10/100BT cabling) or wireless IEEE 802.11, depending on the network infrastructure and broadband Internet connectivity available in the user's home. Other transmission media are also within the scope of this invention.

Processor 10 is a programmable data processor that incorporates the capability to execute generic-computing instructions from software programs fetched from the ROM or the RAM, operate on data in the RAM and control the operations of network adapter 8, audio adapter 11, video adapter 13, and mass storage device 15. The processor may also include specialized internal circuitry to increase the speed of the particular digital signal processing operations involved in decoding and rendering compressed digital video and audio information.

Audio adapter 11 manages the proper formatting and transmission of analog and/or digital audio signals over audio interface 12, which connects the STB to the analog and/or digital audio inputs of the home entertainment center (e.g. audio amplifier, audio/video receiver's audio input ports, or television set audio input ports).

Video adapter 13 manages the proper formatting and transmission of analog and/or digital video signals over video interface 14, which connects the STB to the analog and/or digital video inputs of the home entertainment center (e.g. audio/video receiver's video input ports, video monitor input ports, or television set video input ports).

Mass storage device 15 is a large capacity (currently on the order of 40 to 200 gigabytes) non-volatile digital storage medium and associated control circuitry. Using current technology, it is typically implemented in the form of a magnetic disk (commonly referred to as a “hard drive”) where information is organized in a plurality of independently accessible files. Other mass storage technologies are also within the scope of this invention.

The electronic components of the STB (internal bus 5, RAM 6, ROM 7, network adapter 8, processor 10, audio adapter 11, video adapter 13, and mass storage device 15) are available off-the-shelf from commercial sources and are commonly assembled in a variety of incarnations ranging from general-purpose personal computers to specialized units such as entertainment set-top boxes or embedded control systems. Their functions and internal mechanisms are well understood by practitioners with ordinary skill in the art. Therefore, they are not analyzed herein beyond the above descriptions of their basic functions within the STB.

A set of program files 22 comprises all the binary data that can be loaded into the RAM in order to be interpreted as programs by the processor. Some of these files are loaded into the RAM from the mass storage device at STB startup by another program (commonly called a bootstrap) executed from the ROM; they constitute an underlying operating system software under which control the STB subsystems (user interface, viewer, and virtual store management) are then in turn loaded into the RAM and executed by the processor.

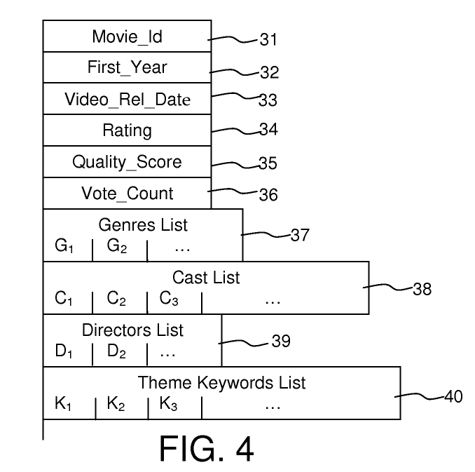

A set of databases 23 comprises all the configuration information and management data used by the STB subsystems. In particular, in the preferred embodiment, it includes three Structured Query Language (“SQL”) databases that are central to the function of virtual store management subsystem 20 and are described in detail under FIGS. 4, 5, and 6. Other databases and database technologies are also within the scope of this invention.

Audio/video storage 24 typically occupies the majority of the space in mass storage device 15. It is a repository of large files that contain the digitally encoded audio and video streams for the movies that are available for immediate rental in the STB. The exact contents of the audio/video storage are decided by virtual store management subsystem 20. These contents are read by viewer subsystem 17 when a stored movie is being viewed.

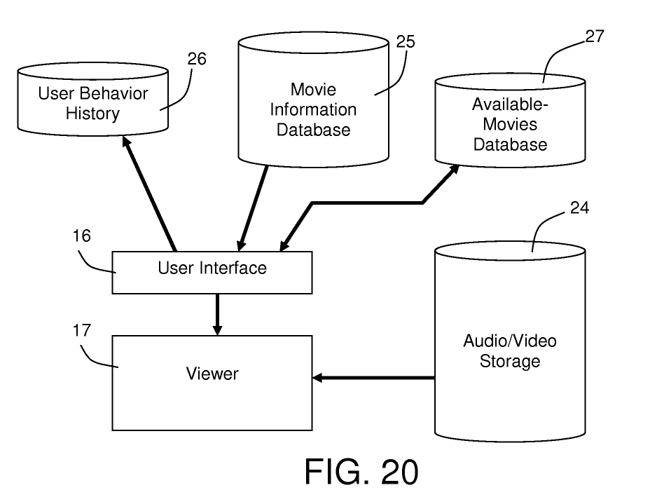

User-interface subsystem 16 displays a set of information and menu screens on the home entertainment video display (e.g. television set) connected to video interface 14 and responds to commands from the handheld remote control unit, thus allowing users to choose the entertainment provided by the STB. In particular, users are able to browse the list of movies available in the STB, preview a movie's “trailer/teaser”, select one of those movies for immediate viewing of the full feature, or search for other movies (not currently available in the STB) to order them for later viewing. The menus also allow users to enter search criteria, such as genre (drama, action, comedy, etc. . . . ), title words, descriptive keywords, or cast members' names, that narrow to scope of the browsing and make finding a desired movie easier. Information screens display summary information about movies such as cast, synopsis, or excerpt pictures. User interface management software programs with features similar to those described above are common in set-top boxes providing Video-On-Demand (“VOD”) entertainment (and also in some cable/satellite TV boxes, for instance those providing Pay-Per-View entertainment). The functions and internal mechanisms of such software programs are well understood by practitioners with ordinary skill in the art. Therefore, they are not analyzed herein beyond the above high-level functional description. The interactions of the user-interface subsystem with elements of virtual store management subsystem 20 are described in FIG. 20.

Viewer subsystem 17 decodes digitally encoded audio and video streams associated to a movie or a movie preview (“trailer/teaser”), displays the corresponding video on the home entertainment video display connected to video interface 14, and transmits the corresponding audio signal to the home entertainment systems audio inputs connected to audio interface 12. The digitally encoded audio and video streams thus processed by the viewer subsystem are read from audio/video storage 24, according to user choices made via user-interface subsystem 16. The viewer subsystem also accepts commands from the same handheld remote control unit used by the user-interface subsystem, allowing the user to stop, pause, restart, and skip forward/backward during the movie playback, in a similar fashion to what is possible when using a DVD player. Decoder subprogram 18 and DRM subprogram 19 are two core components of the viewer subsystem. When a digitally encoded movie being viewed is protected against unauthorized playback by cryptographic methods, the DRM subprogram retrieves the necessary cryptographic certificates and/or keys (from information stored within set of databases 23 and/or by requesting information from the appropriate content provider system via network interface 9) and decrypts the audio and video streams read from audio/video storage 24 as needed. The decoder subprogram performs the decoding of the compressed audio and video information provided by the DRM subprogram (or read directly from the audio/video storage when the movie is not cryptographically protected), according to the compression algorithms used for that movie, and outputs the proper audio and video signals. Audio/video playback software programs with features similar to those described above are present in typical home computers as well as set-top boxes providing Video-On-Demand entertainment. The functions and internal mechanisms of such software programs are well understood by practitioners with ordinary skill in the art. Therefore, they are not analyzed herein beyond the above description. The interactions of the viewer subsystem with elements of virtual store management subsystem 20 are described in FIG. 20.

Virtual store management subsystem 20 controls what entertainment (in the form of movies that can be rented and viewed) is available in the STB, in accordance with an automated continuous analysis of the users' tastes and preferences. In particular, that subsystem is in charge of the contents of audio/video storage 24. The virtual store management subsystem constitutes the core of the present invention and is described in detail below.

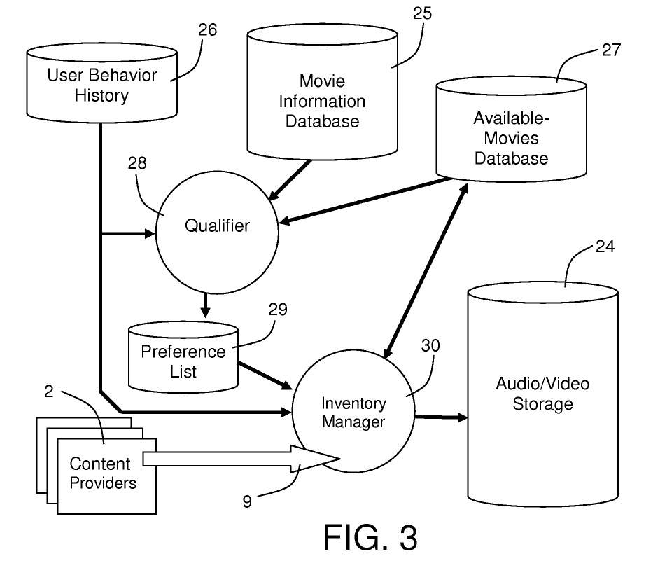

FIG. 3 illustrates the high-level elements that take part in the operation of a virtual store management subsystem. A qualifier task 28 combines information from a movie information database 25, a user behavior history database 26, and an available-movies database 27 to compose a preference list 29. An inventory manager task 30 then combines the preference list with information from user behavior history database 26 and available-movies database 27 to decide the contents of audio/video storage 24. The inventory manager task adds or deletes stored movies, downloading needed movie files from set of content provider systems 2 via network interface 9.

A movie information database 25, the contents of which are specified in further detail under FIG. 4, contains data that is relevant to qualifier task 28 for all the movies that can potentially be referenced by user behavior history database 26 and available-movies database 27. In both the latter databases, each reference to a specific movie is implemented as a movie identification number that designates that specific movie and can be used by the qualifier task as a key into the movie information database to retrieve the relevant records and access data such as lists of involved actors, directors, ratings, age, movie genre classification and themes. The movie information database is built as a local replica of the relevant subset from a global encyclopedia of movie information, either one proprietary to the VOD service provider or a commercially available one. There is a variety of sources for the latter type, for instance the IMDb® service, trademarked and maintained by Internet Movie Database, Inc.

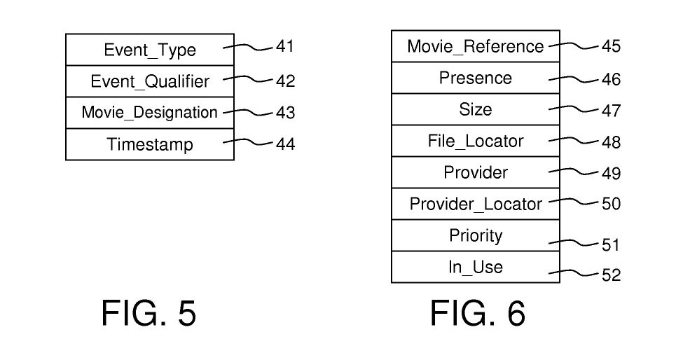

User behavior history database 26, the contents of which are specified in further detail under FIG. 5, accumulates information about past interactions between the user and the system's user interface, such as rental of a specific movie, special-ordering a movie, selecting a movie in a shortlist as a prelude to making a final rental selection, requesting a refund due to returning a rental without finishing viewing it and entering an appraisal after viewing a rental. Except for the latter type of interaction that entails user feedback for the explicit purpose of gathering preference information, the collection of this history information is performed by unobtrusively observing the user's commands to the STB and therefore does not increase the amount of user actions compared to prior art VOD systems. The creation of new records in the user behavior history database is the consequence of user actions and as such, it is performed by the user-interface subsystem as described in FIG. 20.

Available-movies database 27, the contents of which are specified in further detail under FIG. 6, lists all the movies that can be either immediately rented, due to being already stocked in the virtual rental-store, or special-ordered for later rental by the user. Essentially, this database lists all the movies that are available from set of content provider systems 2 and designates which of those movies are actually stored in audio/video storage 24. The role of keeping the available-movies database up to date lies with inventory manager task 30.

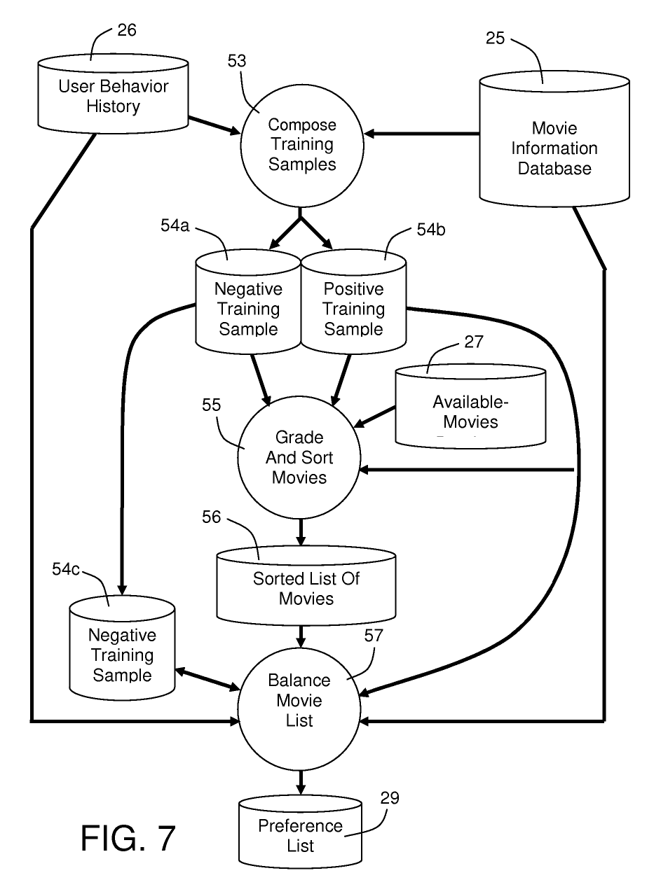

A qualifier task 28, the components of which are specified under FIG. 7, constructs preference list 29 by sorting the items listed in available-movies database 27 according to the user tastes and preferences it infers from information stored in user behavior history database 26. Once the preference list is up-to-date, the qualifier task preferably becomes inactive until processing is reactivated by the occurrence of a change in either the user behavior history database or the available-movies database. Preference list 29 is preferably implemented simply as an ordered list of identifiers that each reference the corresponding record in the available-movies database.

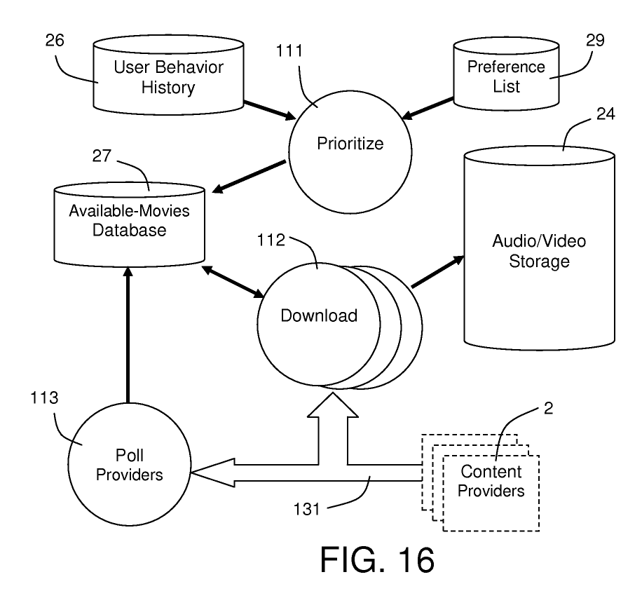

An inventory manager task 30, the components of which are specified under FIG. 16, processes inventory changes whenever qualifier task 28 updates the preference list 29. The inventory processing lasts until the local contents of the virtual rental-store, as embodied in audio/video storage 24, are optimized according to the priorities expressed by preference list 29. In the course of this process, the inventory manager task deletes files that correspond to movies that are no longer worth keeping, thus freeing space for preferred selections, and conducts download operations through the communication network from the appropriate sources of movie files among set of content provider systems 2. As the contents of audio/video storage 24 are changed, the inventory manager task updates the related records in available-movies database 27, to reflect the actual immediate availability of the corresponding rental items.

The inventory manager task 30 also monitors external changes that affect available-movies database 27, as the list of movies offered by each content provider is updated with new movies being introduced or previously available-movies being withdrawn. To that effect, the inventory manager task periodically polls, via the network interface 9, a set of content provider systems 2, detecting changes in their catalog, and updating the available-movies database accordingly. Such updates then cause qualifier task 28 to be activated, resulting in a rewritten preference list 29 and subsequent processing of inventory changes by the inventory manager task.

FIG. 4 shows the fields that typically compose a record in movie information database 25. A movie identifier 31, a first release year 32, a video release date 33, a rating label 34, a quality score 35, and a vote count 36 are preferably stored as single-value fields. A genres list 33, a cast member list 38, a directors list 39, and a theme keywords list 40 are preferably stored as unordered lists containing each zero, one, or multiple identifiers, each uniquely designating a single item of the proper type, respectively a genre, a cast member, a director, and a theme keyword. As is described in more detail further below, the virtual store management subsystem relies in part on the ability to compute a measure of similarity between candidate movies and other movies for which the fondness or dislike of the user is known. For this purpose, numerical identifiers that can be compared between movies are typically quite sufficient and although human-readable textual values for these items could be of use in other parts of the VOD system, for instance in the user-interface subsystem to allow sorting or filtering of movies by genre or cast, such textual values are irrelevant to the internal operation of the virtual store management subsystem in a preferred embodiment of the present invention.

The movie information database is preferably implemented as a relational database, using commodity database management software and is accessed via statements written in SQL (industry-standard Structured Query Language). Within that framework, the aforementioned records are typically implemented as rows in a table, with each field corresponding to a column. As is customary in such a structure, each field that corresponds to a list of items is implemented via a “Join” operation with an ancillary table containing the list items for all of the main table's rows. For the sake of readability, this customary list-implementation detail is not depicted in FIG. 4 where lists are simply shown as record elements, on a par with single-valued fields.

The Movie identifier 31 is preferably a natural number that uniquely identifies the particular movie described by the record. This Movie identifier 31 (natural number in this embodiment) is used by records in user behavior history database 26 and available-movies database 27 to reference related records in the movie information database.

The First release year 32 is preferably a natural number indicating the year that the movie was first released for public viewing, as a theatrical feature, in home video format, or broadcast television, whichever is the earliest.

The Video release date 33 is the date when the movie was first made available in a home video format, either as a video cassette (typically VHS), a DVD, or a digital VOD service. This cannot be earlier than first release year 32. It is preferably coded as a text string in the standard date format for the commodity database management software used to manage the movie information database, namely the ANSI SQL date format that specifies the year as 4 digits, a dash sign, the month as two digits (01 through 12), a second dash sign, and the day within the month as two digits (01 through 31).

The Rating label 34 consists of a restrictive or advisory label assigned to the movie, relating to the sensibilities and level of maturity of its expected audience. It is typically stored as a short text label such as those assigned by the Moving Picture Association of America (“MPAA” rating): “G”, “PG”, “PG-13”, “R”, and “NC-17”. For foreign movies that do not have an MPAA rating but have a similar purpose label assigned in another country's rating system, a corresponding short label is stored, for instance “MA15” (for a maturity level of intended audiences set at 15 years of age or older). Movies for which producers have not sought any rating may be labeled “NR”; those are typically small budget productions or special interest features. Other movies are released in two versions intended for different audiences; one version is assigned a normal MPAA rating and the other, typically containing added mature or violent content, has no such rating. A label “UR” (for unrated) may be stored for the later version, and is typically understood as implying a level of maturity slightly beyond “NC-17”.

The Quality score 35 is preferably a number that describes the relative quality of the movie on a scale from 1 to 10, calculated as the average from a number of votes expressed by a large population of volunteer reviewers.

The Vote count 36 is preferably a natural number that totals the votes that are voluntarily cast by viewers to obtain the quality score above. This is used as a measure of popularity: the more popular a movie, the larger the number of people who express their opinion on it. The vote count is also considered as indicative of the legitimacy of quality score 35. A score generated from a low number of votes (e.g. below 100) is likely to only reflect the opinion of a non-representative segment of the public with possibly extreme, positive or negative, views on the movie in question. Therefore, the raw quality score derived from such a sparse vote cannot typically be taken at face value. On the other hand, large numbers of votes (e.g. above 1000) tend to reflect the opinions of a more balanced voter population and are considered more credible. The preferred formula used for this purpose is described in detail in FIG. 13.

The Genres list 37 enumerates the genres that the movie belongs to, from a set such as: action, adult, adventure, animation, comedy, crime, documentary, drama, family, fantasy, horror, music, musical, mystery, romance, sci-fi, short, thriller, war, and western.

The cast member list 38 and directors list 39 enumerate respectively the actresses or actors who lent their talents to the movie in (in billing order so the top few, e.g. the first 5, can easily be identified), and the individual or individuals who directed it.

The theme keywords list 40 enumerates subjects depicted in the movie or other characteristics that, being shared by multiple movies, can be used to establish a degree of similarity and relate to aspects that a viewer may like or dislike. Theme keywords are typically single words, word groups, or synonyms thereof extracted from the movie's description or synopsis and are numerous.

FIG. 5 shows the fields that typically compose a record in user behavior history database 26. Each record is typically implemented as a row in a single table containing columns for: an event type 41, an event qualifier 42, a movie designation 43, and a timestamp 44. Each record represents a user action regarding a specific movie and, explicitly or implicitly, provides the system with insight about the user's preferences. Depending on the nature of the user action it denotes, each history record is interpreted as a positive, neutral or negative appraisal of the attributes listed in the movie information database for the corresponding movie.

The user behavior history database is preferably implemented as a relational database, using commodity database management software and is accessed via statements written in SQL. Within that framework, the aforementioned records are typically implemented as rows in a table, with each field corresponding to a column.

The event type 41 is preferably a numeric code that describes the user action as, for example, one among the following: explicit-appraisal, special-order, hold, shortlist, rental, return, permanent-exclusion or temporary-exclusion.

An explicit-appraisal event indicates that the user has entered an opinion about the movie, for the explicit purpose of informing the system of that opinion. Such an event occurs typically as the result of the user responding to an optional questionnaire proposed at the end of the viewing of a rented movie, grading a proposed movie without viewing it, or responding to an initial questionnaire intended to coarsely tailor the system to the user's tastes.

A special-order event occurs when the user requests a movie that is not already stocked in the virtual rental-store and is therefore not available for immediate viewing. Such an event causes the system to download the desired movie as soon as possible and is implicitly interpreted by the system as a strong indication that the user likes some aspects of that particular movie.

A hold event occurs when the user explicitly requests that a movie already stocked in the virtual store be retained a certain amount of time, presumably for planned future viewing. It is implicitly interpreted by the system as an indication that the user likes some aspects of that particular movie.

A shortlist event indicates that, while browsing the virtual store for a rental, the user has selected the concerned movie to be placed in a short list of candidates from which a final choice will be made. This is implicitly interpreted by the system as an indication that the user likes some aspects of that particular movie, at least slightly so.

A rental event indicates that the user has rented a movie. This is implicitly interpreted by the system as an indication that the user likes some aspects of that particular movie, more so than in the case of a shortlist event.

A return event indicates that the user rented a movie but, while viewing it, elected to terminate the rental prematurely, possibly obtaining a refund for the rental fee in the process. This is implicitly interpreted by the system as an indication that the user dislikes some aspects of that particular movie.

An exclusion event can be of two types: permanent or temporary. A permanent-exclusion indicates that the movie in question will not be rented ever, typically because the user already owns it, for instance on DVD. A temporary-exclusion indicates that the movie in question has already been viewed, for instance because the user has recently rented it from some other source, but may eventually wish to rent it again in the future, so the event may expire and thus be ignored after a configurable amount of time has elapsed. An exclusion event is not, in itself, interpreted by the system as an implicit indication of predilection or dislike. Typically, however, the user input that results in an exclusion event does carry such a meaning (for instance ownership of a DVD is indicative of predilection for that particular movie) in which case that meaning can be separately embodied in an explicit-appraisal event.

Event qualifier 42 is typically an integral number that further refines the event. Its interpretation depends on the event type. For explicit-appraisal events, the event qualifier indicates the opinion entered by the user, as for example, as a negative −1, −2, or −3 respectively to express a mild dislike, a strong dislike, or a loathing of the movie, a zero for a neutral opinion, and a positive +1, +2, or +3 respectively to express a slight fondness, strong like, or outright love for that movie. For hold events, the event qualifier indicates the duration of the hold, in days. The event qualifier field is typically not used for special-order, shortlist, rental, return, permanent-exclusion, and temporary-exclusion events.

The movie designation 43 is typically a natural number that designates the movie that the event is about, referencing a record in the movie information database by matching the value of its movie identifier 31.

The timestamp 44 indicates the date and time at which the event occurred. This information may be used to determine validity, for those events that may expire or change meaning after a certain time has elapsed; it also establishes precedence amongst competing events.

For the purposes of inferring user tastes and preferences within qualifier task 28 when multiple history records of the same event type regard the same movie, i.e. when they have the same movie designation, preferably only the most recent record is taken into consideration. On the other hand, events that are of different types are preferably treated completely independently of each other. For instance, a rental event may be followed by a return event for the same movie; the negative feedback implied by the return event is processed by the qualifier task separately from the positive feedback ensuing from the rental event and does not directly cancel it. Positive and negative feedbacks are eventually combined within the qualifier task and that process emphasizes corroborating elements of feedback related to various movie attributes. Thus, positive feedback on a movie may stress the user's fondness of a particular cast member while negative feedback on that same movie may instead stress the user's dislike of a certain theme keyword.

For the purposes of determining, within qualifier task 28, the movies to be excluded from preference list 29 and, within inventory manager task 30, the movies to be held in audio/video storage 24 regardless of the preference list, implicit indications as well as explicit hold and exclusion events are preferably taken into account as follows: an implicit hold indication is derived from any rental or special-order event that has occurred recently, within a configurable rental-hold or, respectively, special-order-hold period; an implicit exclusion indication is derived from any rental or return event that has occurred within a configurable rental-exclusion or, respectively, return-exclusion period; for rental events, the rental-exclusion period starts immediately after the rental-hold period ends; Finally, any exclusion or hold, explicit or implicit, is cancelled by a more recent exclusion or hold, explicit or implicit, event concerning the same movie.

FIG. 6 shows the fields that typically compose a record in the available-movies database 27. Each record is preferably implemented as a row in a single table containing columns for: a movie reference 45, a presence indicator 46, a movie size 47, a file locator 48, a provider identifier 49, a provider locator 50, and a priority 51.

The available-movies database is preferably implemented as a relational database, using commodity database management software and is accessed via statements written in SQL. Within that framework, the aforementioned records are typically implemented as rows in a table, with each field corresponding to a column.

The movie reference 45 is typically a natural number that designates the movie that the record is about, referencing a corresponding record in the movie information database by matching the value of its movie identifier 31.

The presence indicator 46 typically contains a coded numerical value that indicates the availability of the corresponding movie, with codes to preferably indicate the following five availability states: local; remote; pending; cancelled; and deleted. The “local” code indicates that the corresponding movie is present in audio/video storage 24 and therefore is available for immediate viewing. The “remote” code indicates that the movie is not present in the audio/video storage but is available for download from one of content provider systems 2. The “pending” code indicates that the movie is currently being downloaded from one of the content provider systems; “local” will replace that code when the download completes normally. Both the “cancelled” and “deleted” codes correspond to transient states and indicate that the movie is no longer available from the content provider systems; the corresponding records will eventually be deleted from the database altogether. In the “cancelled” case, the corresponding movie files are still present in the audio/video storage but further rentals are not allowed. In the “deleted” case, there are no associated files in the audio/video storage.

The movie size 47 is a typically natural number that specifies the amount of mass storage required to hold the movie data. This represents either the amount of space taken by the movie within audio/video storage 24 or, if the movie is not stored there, how much free space would be required to allow it to be downloaded.

The file locator 48 typically contains a text string that specifies the name of the file where the movie data is stored within audio/video storage 24. This file locator field is typically meaningful only when presence indicator 46 indicates “local”.

The provider identifier 49 is typically a natural number that identifies the content provider (a company or some other commercial or non-profit entity) that makes the movie data available for download, among a list of the content providers known to the system. Each entry in this list of known content providers associates the provider identifier with a network location where a catalog of the movies that the provider makes available can be downloaded.

The provider locator 50 typically contains a text string that specifies the network location, among set of content provider systems 2, from which the movie data can be downloaded.

The priority 51 is typically a natural number that represent a priority, for download and/or retention purposes, with zero representing the lowest possible priority. This field's value is typically set and used only within inventory manager task 30.

The in-use flag 52 typically contains a Boolean value that indicates, when set to “true”, that the corresponding movie files in audio/video storage 24 are currently being accessed and that those files and the associated records in the available-movies database should not be deleted under any circumstances until the in-use flag is set to “false”. The virtual store management subsystem never sets this field to “true”, but any other subsystem that accesses the audio/video storage files (e.g. for movie playback) preferably should do so while the files are being read and should reset the field to “false” when finished.

FIG. 7 shows the elements that typically compose the qualifier task 28. A training samples composer subtask 53 combines information from movie information database 25 and user behavior history database 26 to build a negative training sample 54a and a positive training sample 54b. Once this pair of training samples is complete, a grading-and-sorting subtask 55 applies them as criteria to the attributes, from the movie information database, of each of the movies listed in available-movies database 27, thereby generating a sorted list of available-movies 56. Once this is complete, a list-balancing subtask 57 generates a preference list 29 from the sorted list of available-movies by removing some entries and reordering the remaining ones, grading them in a similar fashion as in subtask 55, again applying as criteria positive training sample 54b and applying a secondary negative training sample 54c that is preferably initially formed as a pure copy of negative training sample 54a and is then progressively updated during the processing of the balancing subtask.

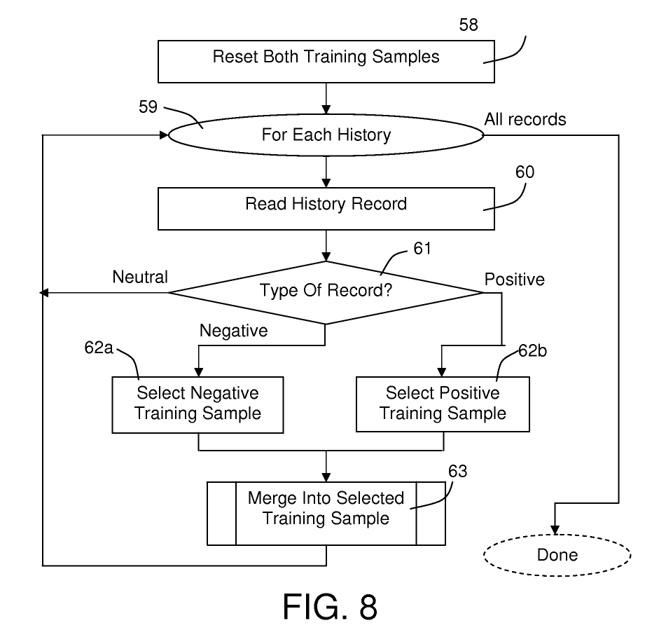

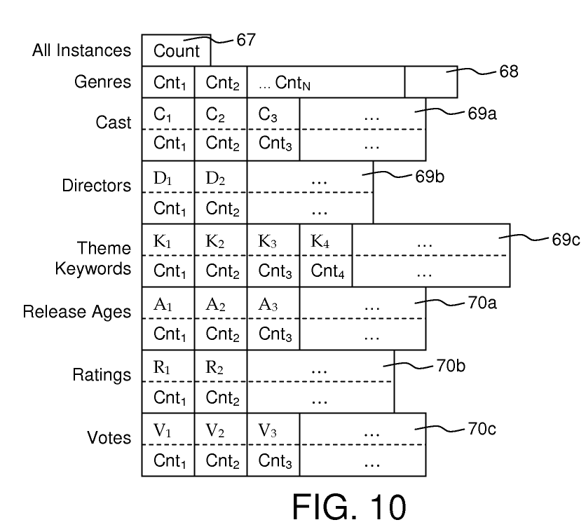

The training samples are typically compilations of user behavior history and the associated relevant movie information, in a form that eventually facilitates the application of formulas used to compute, for each particular movie, a qualification score that reflects how well the movie in question matches the body of user choices expressed in the training sample. Positive training sample 54b accumulates elements from the user behavior history that reflect predilections, whereas negative training sample 54a accumulates those elements that reflect dislikes. User behavior history records that do not reflect either predilections or dislikes are preferably not entered into any training sample. The internal structure of the training samples is described in FIG. 10 and the execution steps of training samples composer subtask 53 are described in FIG. 8.

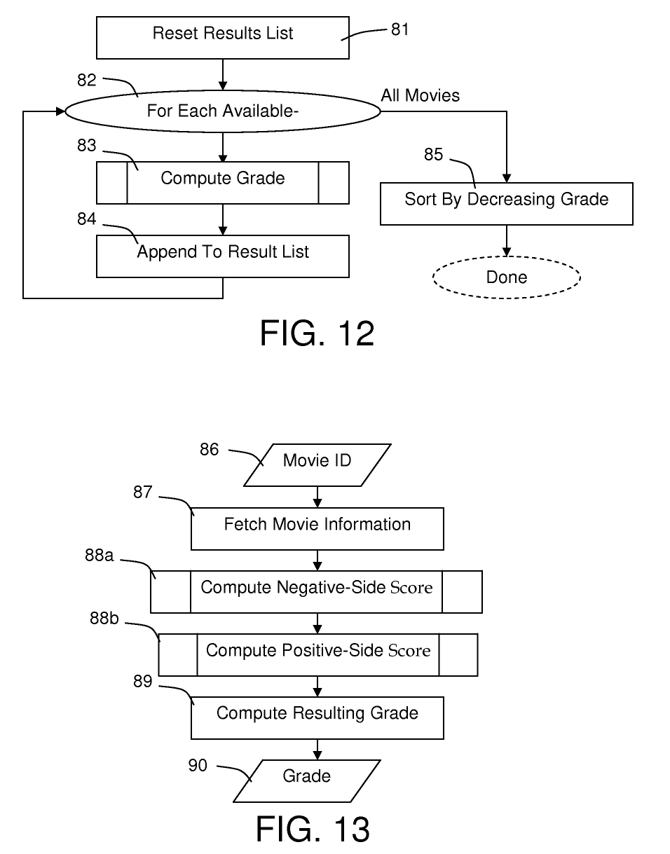

The execution steps of grading-and-sorting subtask 55 are described in FIG. 12. This subtask assigns a grade to each movie mentioned in available-movies database 27. The sorted list of available-movies 56 preferably consists solely of a sequence of movie identifiers sorted by order of decreasing grade. The value of each such movie identifier is the value of movie reference 45 for the corresponding record in the available-movies database.

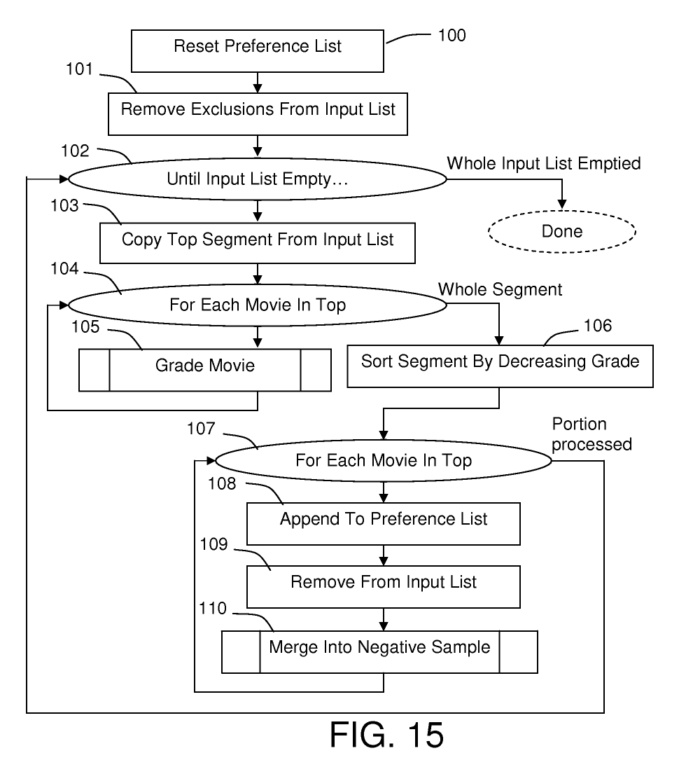

The execution steps of list-balancing subtask 57 are described in FIG. 15. While the sorted list of available-movies 56 references all the movies from available-movies database 27, the final result of the whole qualifier task preferably only mentions movies that are reasonably expected to be rented by the user. Therefore, entries from the sorted list of available-movies that are subject to an explicit or implicit exclusion event in user behavior history database 26 are skipped and do not appear in preference list 29. A second and main purpose of the balancing subtask is to mitigate the influence of strong areas of user preference that would otherwise cause the audio/video storage to be dominated by movies of a single variety. A user may have multiple very distinct areas of interest in movies or the family members in a dwelling sharing the same STB may have very different tastes. If, for example, the virtual store management subsystem in an STB were to observe that a significant majority of movies rented were of the violent action/adventure variety, the top of sorted list of available-movies 56 would tend to weight heavily in that direction, quite possibly with enough eligible entries to fill the entire virtual store inventory with only that kind of movies. The balancing subtask compensates for dominating areas of preference by reordering the list according to the original positive training sample 54b and, on the negative side, a copy 54c of negative training sample 54a into which the top entries of preference list 29 are merged after having been selected for that position in the preference list. As a result, areas of interest that dominate the top of the preference list tend to loose importance in the grading criteria as the list grows, allowing lesser areas of interest to gain influence and thus actually participate in the composition of the virtual store.

FIG. 8 shows the steps executed by training samples composer subtask 53.

At initial step 58, the negative and positive training samples (respectively 54a and 54b) are emptied to start afresh. Step 59 controls a loop that typically executes once for each relevant record in user behavior history database 26 and is exited when all the records have been processed, at which point the training samples composer subtask terminates. The relevant records are typically obtained from the database through an SQL query that considers only records containing appraisal information (implicit or explicit) and, for each group of those that share the same movie designation 43 and event type 41, issues only the most recent one. The SQL query in question can be written as:

SELECT h.* FROM history h INNER JOIN (
SELECT movie_designation, event_type, MAX(timestamp) as maxdate

FROM history
WHERE event_type IN (explicit_appraisal, special_order, hold,
shortlist, rental, return)
GROUP BY movie_designation, event_type) AS m

ON h.movie_designation = m.movie_designation

AND h.event_type = m.event_type
AND h.timestamp = m.maxdate;

During the successive iterations of loop 59, the records are typically read sequentially one by one from the above user behavior history database query (at step 60) and then processed.

Decision step 61 establishes the type of the record on the basis of its event type 41 and event qualifier 42. The record is preferably deemed positive in any of the following cases: an explicit-appraisal event with a strictly positive event qualifier value; a special-order event; a hold event; a shortlist event; or a rental event. The record is preferably deemed negative in any of the following cases: an explicit-appraisal event with a strictly negative event qualifier value; or a return event. Any record that is neither positive nor negative is preferably deemed neutral and is eliminated from further processing (the only possible such case is an explicit-appraisal event with zero as the value of the event qualifier).

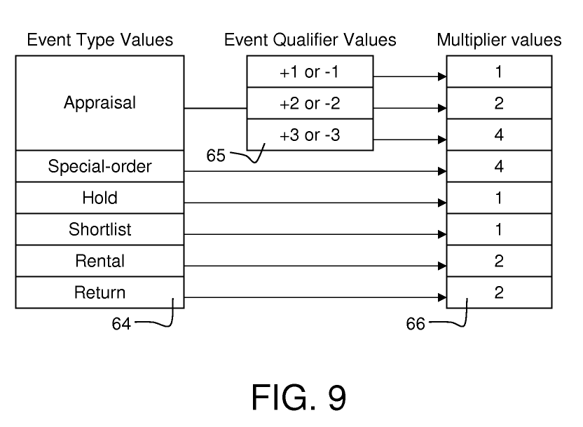

Step 62a, or respectively 62b, determines the multiplier factor for the record and selects the appropriate training sample (54a, or respectively 54b) into which the history information is to be merged. A configurable mapping table specifies the multiplier factor associated to each possible event type and event qualifier (see FIG. 9).

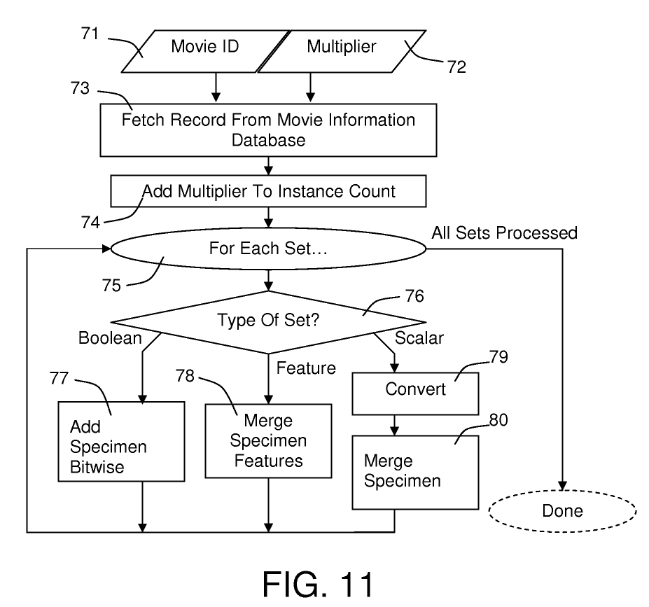

At step 63, the procedure to merge an appraisal into the selected training sample (specified in further detail under FIG. 11) is invoked, after which the processing proceeds to the next history record at step 59.

FIG. 9 shows the mapping used to assign a multiplier factor to an appraisal that is expressed by a record from user behavior history database 26. For each entry in a set of event type values 64 and, when further qualification is needed, each entry in a set of possible event qualifier values 65, the mapping yields an entry in a set of multiplier factor values 66. The multiplier factor is typically a natural number that corresponds to the strength of the appraisal expressed by an event. A single event with a multiplier factor “M” is simply equivalent, when merged into a training sample, to the merging of M instances, each with a multiplier factor of 1, of the same event. These multiplier values preferably are configurable and the particular values depicted in 66 are the currently preferred ones.

FIG. 10 shows the contents of a training sample data structure. In addition to a count of all instances 67, a set of natural numbers is stored for each attribute from the movie information database that is relevant to the grading of movies within qualifier task 28. Each such natural number preferably acts a counter of the number of instances where the corresponding item was referenced in a movie merged into the training sample. The sets are preferably divided into three classes, according to the nature of the related movie attributes. A genres set 68, related to genres list 37, is preferably classified as a Boolean set. A cast set 69a, a directors set 69b, and a theme keywords set 69c (respectively related to cast member list 38, to directors list 39, and to theme keywords list 40) are preferably classified as feature sets. A release ages set 70a, a ratings set 70b, and a votes set 70c (respectively related to the combination of first release year 32 and video release date 33, to rating label 34, and to vote count 36) are preferably classified as scalar sets.

The Boolean set class is appropriate for any movie attribute that consists of a list of properties from a small number of possible ones, where both the presence or absence of a property in a movie convey pertinent information when merged into the training sample. In the preferred embodiment of the present invention, the genres list is the only such attribute. The genres set 68 is preferably implemented as an array of natural numbers, each acting as a count of the number of instances where the corresponding property (i.e. genre amongst the N ones specified for genres list 37, e.g. action, adult, adventure, animation, comedy, crime, documentary, drama, family, fantasy, horror, music, musical, mystery, romance, sci-fi, short, thriller, war, and western) was present in a movie merged into the training sample. Conversely, the number of instances where a genre was absent is easily derived by subtracting from count of all instances 67.

The feature set class is appropriate for any movie attribute that consists of a list of properties from a large number of possible ones, where only the presence of a property in a movie conveys pertinent information when merged into the training sample. In the preferred embodiment of the present invention, the cast member list, the directors list, and the theme keywords list are such attributes. Correspondingly, cast set 69a, directors set 69b, and theme keywords set 69c are implemented as lists of pairs of property identifier and count. In each pair, the property identifier refers to an element in, respectively, cast member list 38 (identifiers represented in FIG. 10 as C₁, C₂, C₃ . . . ), directors list 39 (identifiers represented in FIG. 10 as D₁, D₂ . . . ), and theme keywords list 40 (identifiers represented in FIG. 10 as K₁, K₂, K₃, K₄ . . . ); the count specifies the number of instances where the corresponding property was present in a movie merged into the training sample.

The scalar set class is appropriate for any movie attribute that consists of a numerical value or a textual value from a known set of possible ones that can be mapped onto a numerical scale. In the preferred embodiment of the present invention, the age of the movie, the rating label, and the vote count are such attributes. Correspondingly, release ages set 70a, ratings set 70b, and votes set 70c are preferably implemented as lists of pairs of scalar value and count. In each such pair, the count specifies the number of instances (of movies merged into the training sample) where the attribute in question maps to the pair's stated scalar value.

In release ages set 70a, each scalar value (represented in FIG. 10 as A₁, A₂, A₃ . . . ) is the natural logarithm of the age in days of a merged movie, or multiple merged movies of the same age, at the time of computation. The age of any movie is based on the difference between an origin date for the movie and the current date. The origin date is preferably a combination of first release year 32 and video release date 33, using the following rule: if the first release year and the year of the video release date are more than 2 years apart, or if the video release date is not known (for instance if the movie was only ever released in theaters with no video release announced yet), the origin date is set to June 30^{th} of the first release year; otherwise, the origin date is set to the video release date. Furthermore, if the origin date is later than the current date (typically this happens if the movie is scheduled to be released on video in the near future) or if the age is less than a configurable minimum age value (365 days in the presently implemented version of this invention's preferred embodiment), the age is set to that minimum age value.

In ratings set 70b, each scalar value (represented in FIG. 10 as R₁, R₂ . . . ) reflects the position of rating label 34 of a merged movie, or multiple merged movies bearing the same rating, within the spectrum of labels typically assigned by the Moving Picture Association of America (MPAA rating). The MPAA rating labels may be translated as follows: “G”→0, “PG”→1, “PG-13”2, “R”→3, and “NC-17”→4. For foreign movies that do not have an MPAA rating but have a similar purpose label assigned in another country's rating system, the restrictive rating code is chosen so that it approximates the foreign rating's position within the MPAA scale. For instance, a label such as “MA15”, that indicates that a movie is intended for viewers at least fifteen years of age, is interpreted as fitting halfway between “PG-13” and “R” and is therefore assigned the value 3.5; labels such as “X” and “UR”, that typically indicate movies intended for adult audiences are interpreted as fitting slightly above “NC-17” and therefore assigned the value 4.5. Other coding schemes are also within the scope of this invention.

In votes set 70c, each scalar value (represented in FIG. 10 as V₁, V₂, V₃ . . . ) is preferably the natural logarithm of a bounded number of votes for a merged movie, or multiple merged movies carrying the same bounded number of votes. This bounded number of votes is derived from the unadulterated vote count by limiting its lower bound to a configurable value (200 in the presently implemented version of this invention's preferred embodiment); thus, the bounded number of votes is equal to vote count 36 whenever the latter is greater than this lower bound and set to the lower bound value otherwise.

In the presently implemented version of this invention's preferred embodiment, in the C++ programming language, the lists of pairs within the training samples for all feature sets (69a, 69b, and 69c) and scalar sets (70a, 70b, and 70c) are built using the “map” construct from the C++ Standard Library. The Boolean set (68) is built using the “vector” construct from the same library.

FIG. 11 shows the steps executed by the procedure to merge an appraisal into a training sample. That procedure is invoked in both the training sample composer subtask (at step 63) and the list-balancing subtask (at step 110). It operates on a training sample specified at invocation time and is given a movie identifier argument 71 and a multiplier argument 72.

At initial step 73, the record identified by the movie identifier argument is read from movie information database 25; the fields of that record (referred to as “movie informationfields” below) will constitute the specimen information that is to be merged into the training sample's sets.

At step 74, the value of multiplier argument 72 is added to count of all instances 67.

Step 75 controls a loop that typically executes once for each set (68, 69a, 69b, 69c, 70a, 70b, and 70c) within the training sample and is exited when all these sets have been processed, at which point the procedure terminates. Decision step 76 establishes the type of the set being processed in each iteration of the loop (scalar, Boolean, or feature) and directs further execution accordingly.

For a Boolean set, step 77 preferably adds the value of multiplier argument 72 to each element of the set corresponding to a property that is present in the related movie information field. Thus, the multiplier argument value is added to those entries of genres set 68 that correspond to a property present in genres list 33 within the record that was obtained from the movies information database in step 73.

For a feature set, step 78 preferably merges the properties from the related movie information field as follows: in any of the set's pairs where the property identifier matches one of the movie information properties, the value of multiplier argument 72 is added to the pair's count; for any of the movie information properties that wasn't matched by any of the set's pairs, a new pair is created and added to the set, using the corresponding property identifier and setting the pair's count to the value of multiplier argument 72. Thus, the properties present in cast member list 38, directors list 39, and theme keywords list 40 within the record that was obtained from the movies information database in step 73 are merged, respectively, into cast set 69a, directors set 69b, and theme keywords set 69c. The procedure makes a special case for cast set 69a: since, in any movie, there are many cast members who hold minor roles and are unlikely to have any relevance regarding user preferences, only the top C_{Max} cast members from cast member list 38 are taken into account; C_{Max} is a configurable value that, in the presently implemented version of this invention's preferred embodiment, is set to 5.

For a scalar set, step 79 preferably converts the related movie information field into a numerical value, following rules specified for the scalar set class (for sets 70a, 70b, and 70c) in the description of the training sample contents. Step 80 then merges this conversion result as follows: if one of the set's pairs bears a scalar value equal to the conversion result, the value of multiplier argument 72 is added to that pair's count; otherwise, a new pair is created and added to the set, using the conversion result as the scalar value and the value of multiplier argument 72 as count. Thus, the specimen information provided by the movie's age (computed from first release year 32 and video release date 33), rating label 34, and vote count 36 is merged, respectively, into release ages set 70a, ratings set 70b, and votes set 70c.

FIG. 12 shows the steps executed by grading-and-sorting subtask 55.

At first step 81, a result list of pairs of a movie identifier and a grade value is created, initially empty. Step 82 controls a loop that preferably executes once for each record in available-movies database 27 and is exited when all the records have been processed, at which point the grading-and-sorting subtask proceeds to step 85.

At step 83, the procedure to compute a grade (specified in further detail under FIG. 13) is invoked, with the current record's movie reference 45 typically as an argument. Step 84 then appends a new pair, composed of the movie reference and the grade issued by the procedure, to the result list.

Once all the available-movies database records have been processed, execution reaches step 85, where the result list is sorted by order of decreasing grade. The grades are then stripped off, leaving only the movie references arranged in the proper order and thus yielding the new instance of sorted list of available-movies 56. The subtask then terminates.

FIG. 13 shows the steps executed by the procedure to compute a grade for a movie. That procedure is invoked in both the grading-and-sorting subtask (at step 83) and the list-balancing subtask (at step 105). It is given a movie reference argument 86 and issues a resulting grade 90 at its completion.

At initial step 87, the record identified by the movie reference argument is read from movie information database 25.

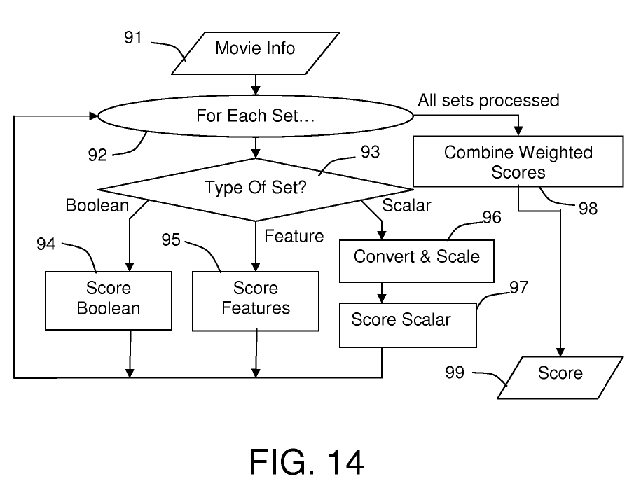

Steps 88a and 88b respectively compute a negative-side score and a positive-side score. They both invoke the procedure to compute a score (specified in further detail under FIG. 14), giving it as an argument the database record read in step 87. The execution of steps 88a and 88b is typically very similar, differing only in the training sample each step uses in its computation. The negative-side score obtained by step 88a results from using negative training sample 54a when the procedure is invoked from the grading-and-sorting subtask, and 54c when the procedure is invoked from the list-balancing subtask. The positive-side score obtained by step 88b results from using positive training sample 54b.

Step 89 calculates resulting grade 90 (noted as G below) from positive-side score Sₚ, negative-side score S_{N}, and a quality factor Q_{F}. The calculation is performed according to the formulas:

$$S = {S}_{P} \times {Q}_{F} and G = \frac{S}{S + {S}_{N}}$$

The quality factor Q_{F} is preferably derived from quality score 35 (noted Qₛ below), vote count 36 (noted V below), a configurable low-vote-threshold V_{L} (set to 100 in the presently implemented version of this invention's preferred embodiment), a configurable base quality score Q_{B} (set to 5.0 in the presently implemented version of this invention's preferred embodiment), a configurable default quality score Q_{D} (set to 5.5 in the presently implemented version of this invention's preferred embodiment), and a configurable quality weight W_{Q} (set to 0.25 in the presently implemented version of this invention's preferred embodiment). The following formulas are used:

$$Q = {Q}_{S} - \frac{{Q}_{S} - {Q}_{D}}{{2}^{( \frac{V}{{V}_{L}} )}} and {Q}_{F} = {( \frac{Q}{{Q}_{B}} )}^{{W}_{Q}}$$

The low-vote-threshold V_{L} in the above formula controls how much credence is given to the raw quality score Q_{S} of a movie, depending on the vote count (see the discussion on quality score credibility in the description of vote count 36 within the movie information database under FIG. 4). For vote counts significantly larger than V_{L}, the intermediate value Q is very close to Q_{S} whereas for low vote counts, Q gravitates towards Q_{D}. Note also that in the peculiar case where quality score 35 is invalid (when there is no vote at all, so vote count 36 is zero), the value of Q_{S} becomes irrelevant and the intermediate value Q is equal to default quality score Q_{D}.

FIG. 14 shows the steps preferably executed by the procedure to compute a score for a movie. That procedure is invoked twice by the procedure to compute a grade (at steps 88a and 88b). It operates on a training sample specified at invocation time, is given a movie information argument 91, and issues a resulting score 99 at its completion.

The movie information argument 91 preferably consists of single record from the movie information database. The fields of that record are referred to as “movie info mationfields” below.

Step 92 controls a loop that executes once for each set (68, 69a, 69b, 69c, 70a, 70b, and 70c) within the training sample and is exited when all the sets have been processed, at which point the procedure proceeds to step 98. Decision step 93 establishes the type of the set being processed in each iteration of the loop (scalar, Boolean, or feature) and directs further execution accordingly.

In general terms, the score calculations performed in steps 94, 95, and 97 are loosely inspired from Naive Bayesian classification methods and are based on deriving probabilities (called “posterior probabilities”) of a movie being liked, or disliked, from the product of the probabilities (called “prior probabilities”) of the various attributes of that movie matching those liked, or disliked, by the user. The prior probability for a given attribute of a given candidate movie is evaluated by measuring how prominently the attribute appears in the considered training sample (positive training sample for likes and negative one for dislikes). In addition, in order to dampen variations that sparsely populated training samples would cause and to guarantee that the absence of some attributes from a training sample still yields coherent scores, a set of attribute-specific probability guesses are associated with a fictitious “equivalent” sample portion injected into the formulas. Those probability guesses are respectively noted P_{G}, P_{C}, P_{D}, P_{K}, P_{A}, P_{R}, and P_{V} for: genres set 68, cast set 69a, directors set 69b, theme keywords set 69c, release ages set 70a, ratings set 70b, and votes set 70c. The number of instances of the associated fictitious “equivalent” sample portion is noted E. The values of these dampening constants are preferably configurable; in the presently implemented version of this invention's preferred embodiment, all probability guesses are set to 0.5 and E is set to 20.

In the score formulas below, the training sample's count of all instances 67 is noted A.

For a Boolean set, specifically genres set 68, step 94 calculates a score S_{G} based on all the Countᵢ values in the set, each appearing in one of the two parts of the formula below depending on the presence or absence of the corresponding genreᵢ among the properties listed in the genre movie information field (of movie information argument 91):

$$\begin{matrix}{S}_{G} = ( {\prod }_{i}^{{genre}_{i} present} \frac{{Count}_{i} + ( E \times {P}_{G} )}{A + E} ) \times \\ ( {\prod }_{i}^{ {genre}_{ i} absent} \frac{( A - {Count}_{ i} ) + ( E \times ( 1 - {P}_{ G} ) )}{A + E} )\end{matrix}$$

For a feature set, step 95 calculates the set's score S_{f} on the basis of all the properties from the related movie information field that are mentioned in the training sample. For any of the set's pairs where the property identifiers matches one of the corresponding movie information field's properties, the value of the pair's Countᵢ is taken into account. Pairs that do not match any of the movie information field's properties are ignored. Thus, the properties present in cast member list 38, directors list 39, or theme keywords list 40 within the movie information fields are matched, respectively, to cast set 69a, directors set 69b, or theme keywords set 69c. The formula below applies specifically to the cast set, the directors set, or the theme keywords set by substituting the respective letter C, D, or K in place of symbol “f”:

$${S}_{f} = 1 - ( ( 1 - \frac{E \times {P}_{f}}{A + E} ) \times {\prod }_{i}^{{f}_{i} matched} ( 1 - \frac{{Count}_{i} + ( E \times {P}_{f} )}{A + E} ) )$$

By the same token as the procedure to merge an appraisal into a training sample, this procedure to compute a score makes a special case for cast set 69a: since, in any movie, there are many cast members who hold minor roles and are highly unlikely to have any relevance regarding user preferences, only the top C_{Max} cast members from cast member list 38 are taken into account; C_{Max} is a configurable value that, in the presently implemented version of this invention's preferred embodiment, is set to 5.

For a scalar set, step 96 converts the related movie information field into a numerical value X, following rules specified for the scalar set class (for sets 70a, 70b, and 70c) in the description of the training sample contents. Step 97 then calculates the set's score S_{f} on the basis of the sum of the probability densities generated at X by normal distributions centered on the values of each instance entered into the training sample. The normal distributions' standard deviation for each set is a configurable value σ_{f} chosen so that, for a hypothetical “canonical” training sample such that the values for each instance are evenly spaced at some canonical interval, the formula yields minimal fluctuation as X goes from the lowest value to the largest. In the presently implemented version of this invention's preferred embodiment: σ_{A} (associated to release ages set 70a) is set so the canonical interval corresponds to a doubling of age, σ_{R} (associated to ratings set 70b) is set so the canonical interval corresponds to a difference of one point, and σᵥ (associated to votes set 70c) is set so the canonical interval corresponds to a doubling of the number of votes. The corresponding configured values are as follows:

$${σ}_{A} = \frac{log 2}{2} {σ}_{R} = \frac{1}{2} {σ}_{V} = \frac{log 2}{2}$$

The formula below applies specifically to release ages set 70a, ratings set 70b, or votes set 70c by substituting the respective letter A, R, or V in place of symbol “f”. The symbol “e” represents the base of the natural logarithm.

$${S}_{f} = \frac{( E \times {P}_{f} ) + {\sum }_{i} \frac{{Count}_{i}}{\sqrt{{ⅇ}^{{( \frac{X - {f}_{i}}{{σ}_{f}} )}^{2}}}}}{A + E}$$

Once all the training sample's sets have been processed, execution reaches step 98, where resulting score 99 (noted S) is calculated by combining all the sets' scores in a product, after having applied to each a configurable set-specific weighing factor (noted W_{G}, W_{C}, W_{D}, W_{K}, W_{A}, W_{R}, and W_{V} for, respectively, genres set 68, cast set 69a, directors set 69b, theme keywords set 69c, release ages set 70a, ratings set 70b, and votes set 70c). Each set-specific weighing factor is applied as an exponent to its corresponding set's score (S_{G}, S_{C}, S_{D}, S_{K}, S_{A}, S_{R}, or S_{V}). The overall formula for S is as follows:
S=S_{G}^{W}^{_{G}}×S_{C}^{W}^{_{C}}×S_{D}^{W}^{_{D}}×S_{K}^{W}^{_{K}}×S_{A}^{W}^{_{A}}×S_{R}^{W}^{_{R}}×S_{V}^{W}^{_{V}}

The weighing factors are determined empirically and are meant to balance the relative influences of the various movie attributes in the overall selection process. In the presently implemented version of this invention's preferred embodiment, their values are: W_{G}=2, W_{C}=0.2, W_{D}=0.2, W_{K}=1, W_{A}=2, W_{R}=2, and W_{V}=0.2. Other values and configurations are also within the scope of this invention.

FIG. 15 shows the steps executed by list-balancing subtask 57. It takes as input sorted list of available-movies 56 (thereafter referred to as “input list”) and progressively empties it, using part of the contents to build preference list 29.

At initial step 100, the preference list 29 is created as a list of movie identifiers, initially empty. Also, negative training sample 54c, that will later be modified during the execution of this subtask, is initially created as a plain copy of negative training sample 54a.

At step 101, all the entries in the input list that correspond to an implicit or explicit exclusion in user behavior history database 26 are typically deleted. The list of exclusions is preferably obtained from the database through an SQL query that considers, for each movie designation 43, only the latest exclusion-relevant event and outputs only records that indicate valid exclusions (implicit or explicit), while taking into account the possibility of an exclusion being cancelled by a more recent event. The SQL query in question can be written as:

SELECT h.movie_designation FROM history h

INNER JOIN (

SELECT movie_designation, MAX(timestamp) as maxdate

FROM history
WHERE event_type IN (special_order, hold, rental,
permanent_exclusion, temporary_exclusion)
GROUP BY movie_designation) AS m

ON h.movie_designation = m.movie_designation

AND h.timestamp = m.maxdate
WHERE h.event_type = permanent_exclusion
OR (h.event_type = temporary_exclusion AND h.timestamp >=
time₁)
OR (h.event_type = return AND h.timestamp >= time₂)
OR (h.event_type = rental AND h.timestamp BETWEEN
time3 AND time4);

In the above SQL query, the time1, time2, time3, and time4 terms are placeholders that represent calculated time values used to assert that an exclusion-relevant event is valid or, in other words, that the current time lies within the event's exclusion period. The exclusion period for each event-type is a configurable quantity. In the presently implemented version of this invention's preferred embodiment, the exclusion periods are set as follows: it lasts 2 years for a temporary-exclusion event, it lasts 1 year for a return event, and it starts 5 days after a rental event and extends for 1 year thereafter. The syntax of time calculations in SQL is not standardized and depends on the database technology (or vendor). The presently implemented version of this invention's preferred embodiment uses the public domain “SQLite” database management software (version 3.2.0 or later, available on-line on the world-wide web from http://sqlite.org) for the user behavior history database. In that SQL dialect, the timei terms are expressed as follows: time1 is “datetime(‘now’, ‘−2 years’)”, time2 is “datetime(‘now’, ‘−1 year’)”, time3 is “datetime(‘now’, ‘−5 days’, ‘−1 year’)”, and time4 is “datetime(‘now’, ‘−5 days’)”.

Step 102 controls a loop that executes until the input list is empty, at which point the list-balancing subtask execution terminates, having completely generated preference list 29.

At step 103, the first N_{S} movie identifiers of the input list are selected for a round of processing and are copied to constitute a segment, composed as a list of pairs of a movie identifier and a grade (which is not assigned any value yet). The use of such a limited-size segment is a processing time optimization over selecting the entire input list: it limits the application of the lengthy, repeated, grading-and-sorting process to only a likely-relevant subset at a time instead of the whole, possibly very large, remaining input list where only a small subset would actually matter at each round. The size of the segment (N_{S}) is a configurable value chosen to be significantly larger than a value N_{P}, the portion size (see step 107 below). In the presently implemented version of this invention's preferred embodiment, N_{S} is set to 1000.

Step 104 controls a loop that executes once for each pair in the segment and is exited when all these pairs have been processed, at which point execution proceeds at step 106. Within the loop, step 105 invokes the procedure to compute a grade (described in FIG. 13), with positive training sample and negative training sample and giving as argument the movie identifier of the current pair. The value of the resulting grade is then assigned to the grade element of the pair.

Once the whole segment has been processed, execution reaches step 106, where the segment is preferably sorted by order of decreasing grade.

Step 107 controls a loop that executes once for each of the first N_{P} pairs of the segment (i.e. the ones with the highest grades). Those first N_{P} pairs are together referred to hereafter as the “portion”. The loop is exited once all the pairs of the portion have been processed, at which point execution processes to the next iteration of loop 102. The size of the portion (N_{P}) is a configurable value chosen to allow the eventual contents of audio/video storage 24 to be composed of a few portions (e.g. 5). Although the exact number of movies in the audio/video storage is ultimately controlled by inventory manager task 30 and depends on the length of each of the eventually selected movies, it is possible to roughly approximate storage capacity by considering how many average-length movies could fit in the audio/video storage. In the presently implemented version of this invention's preferred embodiment, N_{P} is chosen to equal 20% of that capacity figure; for instance, if the audio/video storage holds about 200 average-length movies, N_{P} is set to 40.

At step 108, the movie identifier from the current pair is added to preference list 29. Then, at step 109, the entry bearing that same movie identifier is deleted from the input list. Finally, at step 110, that same movie identifier is merged into negative training sample 54c by invoking the procedure to merge an appraisal into a training sample (described in FIG. 11), giving it as arguments the movie identifier and, as multiplier, a fixed configurable value (set to 1 in the presently implemented version of this invention's preferred embodiment).

FIG. 16 shows the elements that compose inventory manager task 30. A prioritizing subtask 111 combines information from preference list 29 and user behavior history database 26 to update the priority fields in all the records of available-movies database 27. Once this is complete, a download subtask 112 among a plurality thereof selects a candidate movie within the available-movies database and downloads the corresponding movie file from the appropriate content provider system among set 2 via network interface 9. The download subtask stores the received file into audio/video storage 24 and updates the available-movies database to reflect this. A provider-polling subtask 113, operating independently of all the above, interrogates the set of content provider systems via the network interface at regular intervals and updates the available-movies database to reflect changes in movie offerings from providers, such as release of new movies or termination of availability for rental of some previously offered movies.

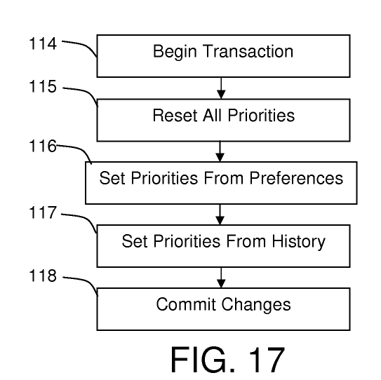

The execution steps of prioritizing subtask 111 are described in FIG. 17. This subtask assigns a value to priority 51 in each record of available-movies database 27, on the basis of each movie's special-order or hold status, and according to preference list 29. The resulting prioritization places ahead movies that are within their rental-hold period, followed by those subject to an explicit hold, further followed by any that are within their special-order hold period (this includes movies special-ordered but not downloaded yet), and finally all the other movies arranged in the order dictated by the preference list.

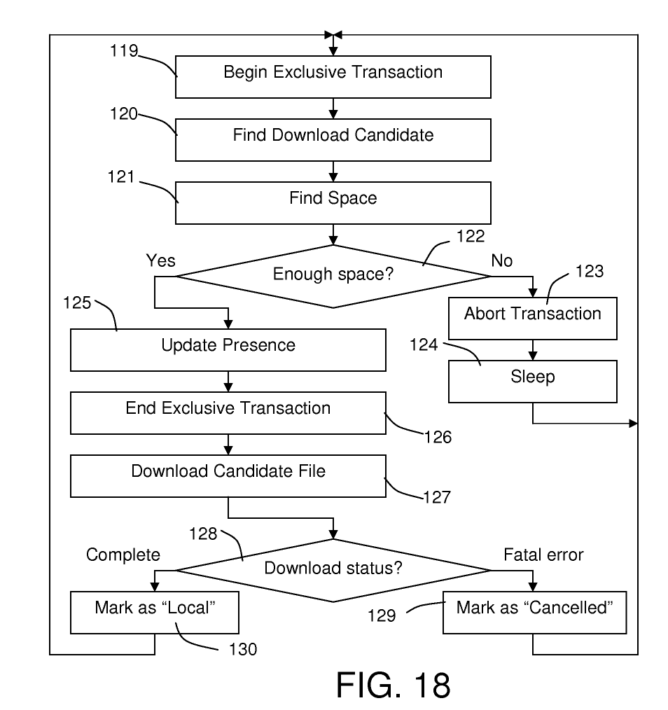

The execution steps of download subtask 112 are described in FIG. 18. There are multiple such subtasks executing in parallel, giving the system the capability to download multiple movies independently from each other and possibly at the same time. The number of download subtasks is a configurable parameter, set to 3 in the presently implemented version of this invention's preferred embodiment. Each download subtask selects the highest priority download candidate it finds in available-movies database 27, according to priority 51, and makes space to store it in audio/video storage 24 by removing the movies with the lowest priority. The download subtasks never terminate but become dormant when there are no more download candidates with higher priority than the movies that would need to be removed to fit a candidate.

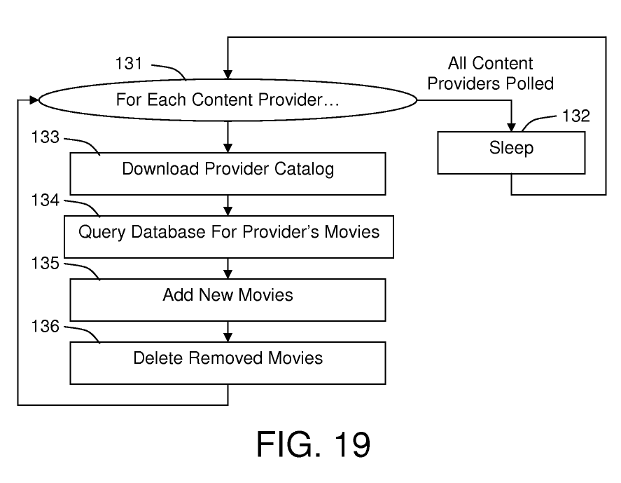

The execution steps of provider-polling subtask 113 are described in FIG. 19. This subtask activates regularly, at a configurable time interval (set to 3 days in the presently implemented version of this invention's preferred embodiment), and is dormant the rest of the time. When active, the subtask obtains a catalog of available movies from each content provider system, compares the resulting lists with the available-movies database 27 and updates the database and the audio/video storage to match.

FIG. 17 shows the elements that compose prioritizing subtask 111.

At first step 114, a transaction is started to allow multiple database content modifications to be performed in an atomic manner (i.e. all at once, see step 118). The SQL statement accomplishing that action is:
BEGIN;

At step 115, priority 51 is reset to zero in all the available-movies database records. The SQL statement accomplishing that action is:
UPDATE available_movies SET priority=0;

At step 116, each record corresponding to a movie in preference list 29 is assigned a new value for its priority 51, corresponding to the movie's rank in the preference list, such that the closer to the top of the list, the larger the priority value. This is performed in a loop as follows: one movie identifier (noted Idₗᵢₛₜ herein) is read from the list at a time, starting from the last element, then the one above it, and continuing up until the top of the list is reached; at each such iteration, the priority field of the record corresponding to the movie identifier is assigned a numerical value (noted Priority_{incrementing} herein) that starts at 1 and is incremented by one at each subsequent iteration; The SQL statement accomplishing the priority value assignment is:

UPDATE available_movies SET priority = Priority_{incrementing}

WHERE movie_reference = Idₗᵢₛₜ;

Once the whole preference list has been read from bottom to top, step 117 increases the priority field for those records corresponding to movies that are subject to special-order or hold status in user behavior history database 26. This priority increase is such that any affected record ends up with a higher priority than any unaffected record. This is accomplished by using increases larger than any possible priority value issued by step 116 above (in the presently implemented version of this invention's preferred embodiment, it is assumed that there are less than a million entries possible in the available-movies database so increases of 1000000 or above are sufficient). The following SQL statements, issued one after the other, accomplish the work within step 117:

UPDATE available_movies SET priority = priority + 4000000

WHERE movie_reference IN (

SELECT h.movie_designation FROM history h INNER JOIN (
SELECT movie_designation, MAX(timestamp) as maxdate

FROM history
WHERE event_type IN (special_order, hold, rental,
permanent_exclusion, temporary_exclusion)
GROUP BY movie_designation) AS m

ON h.movie_designation = m.movie_designation

AND h.timestamp = m.maxdate
WHERE h.event_type = rental AND h.timestamp >= time₄);

UPDATE available_movies SET priority = priority + 2000000

WHERE movie_reference IN (

SELECT h.movie_designation FROM history h INNER JOIN (
SELECT movie_designation, MAX(timestamp) as maxdate

FROM history
WHERE event_type IN (special_order, hold, rental,
permanent_exclusion, temporary_exclusion)
GROUP BY movie_designation) AS m

ON h.movie_designation = m.movie_designation

AND h.timestamp = m.maxdate
WHERE h.event_type = hold AND h.timestamp >= time₅);

UPDATE available_movies SET priority = priority + 1000000

WHERE movie_reference IN (

SELECT h.movie_designation FROM history h INNER JOIN (
SELECT movie_designation, MAX(timestamp) as maxdate

FROM history
WHERE event_type IN (special_order, hold, rental,
permanent_exclusion, temporary_exclusion)
GROUP BY movie_designation) AS m

ON h.movie_designation = m.movie_designation

AND h.timestamp = m.maxdate
WHERE h.event_type = special_order AND h.timestamp
>= time6);

In the above SQL updates, the time₄, time₅, and time₆ terms are placeholders that represent calculated time values used to assert that a hold-relevant event is valid or, in other words, that the current time lies within the event's hold period. The hold periods for rental and special-order events are configurable quantities. In the presently implemented version of this invention's preferred embodiment, the hold periods are set as follows: it lasts 5 days for a rental event (that particular value is also used in step 101 of list-balancing subtask 57) and it lasts 1 month for a special-order event. The hold period for a hold event is specified in event qualifier 42 within the event record. The syntax of time calculations in SQL is not standardized and depends on the database technology (or vendor). In the “SQLite” SQL dialect used in the presently implemented version of this invention's preferred embodiment, the timeᵢ terms are expressed as follows: time₄ is “datetime(‘now’, ‘−5 days’)”, time₅ is “datetime(‘now’, ‘−’ || h.event_qualifier || ‘days’)”, and time₆ is “datetime(‘now’, ‘−1 month’)”.

Note also that the public domain “SQLite” database management software used in the presently implemented version of this invention's preferred embodiment allows the kind of relational “joins” between tables from separate databases used in the SQL statements of step 117 above. In an alternate implementation that would use different database management software without such a capability, it would be necessary to implement the user behavior history and available-movies as separate tables within one database instead of the two separate databases described herein.

At last step 118, the transaction started at step 114 is completed, causing the multiple content modifications performed in steps 115, 116, and 117 to actually affect the database in an atomic manner, not allowing any other intervening content modification by any other program or task accessing the database at the same time. The SQL statement accomplishing that action is:
COMMIT;
   Prioritizing subtask 111 terminates after step 118 has been executed.

FIG. 18 shows the elements that compose download subtask 112.

At first step 119, an exclusive access transaction is started to allow multiple database content modifications to be performed in an atomic manner (i.e. all at once) and also make sure no other download subtask interferes with the operations that follow, until either step 123 or step 126 is reached. The SQL statement accomplishing that action in the SQLite dialect used in the presently implemented version of this invention's preferred embodiment is:
BEGIN EXCLUSIVE;

At step 120, the current highest priority download candidate is identified, using the following SQL query which also yields, for use in subsequent steps, size (thereafter noted S_{candidate}) and priority (thereafter noted P_{candidate}):

SELECT movie_reference, size, priority FROM available-movies

WHERE presence = remote
ORDER BY priority DESC LIMIT 1;

At step 121, the amount of audio/video storage space available is computed. This involves identifying any low-priority locally-stored movies that have to be removed from the audio/video storage to make room for the new download candidate identified at step 120. The total capacity of the audio/video storage being a known quantity (noted S_{storage}), the following SQL query yields the space (thereafter noted S_{free}) currently unused in the audio/video storage:

SELECT S_{storage} - sum(size) FROM available_movies

WHERE presence IN (local, pending, cancelled);

The following SQL query yields a list of removable movies, in order of removal precedence, along with their sizes and file locator:

SELECT movie_reference, size, file_locator FROM available_movies

WHERE presence = local AND in_use = false AND priority <
P_{candidate}
ORDER BY priority DESC;

Step 122 determines whether enough space can be made available for the new download candidate. If S_{candidate} is greater than S_{free} added to the sum of all the sizes in the list of removable movies (obtained at step 121), there is not enough audio/video storage capacity for the download candidate. In that case, execution proceeds to step 123. Otherwise, there is enough audio/video storage capacity, and execution proceeds to step 125.

At step 123, reached if download is not possible due to lack of storage capacity, the transaction started at step 119 is abandoned, by issuing the following SQL statement:
ROLLBACK;
   This also causes exclusive access to the database to be relinquished. Then, at step 124, the download subtask is put in a dormant state until a change occurs in the available-movies database. When the download subtask is reactivated, execution proceeds to step 119.

At step 125, reached if there is enough storage capacity, the presence field of the download candidate's record in the available-movies database is set to “pending” and the necessary movie removals take place, performed as follows, while S_{free} is less than S_{candidate}: starting from the beginning of the list of removable movies (obtained at step 121), the size is added to S_{free}, the corresponding file (identified by the file locator) is deleted from the audio/video storage, and the presence field in the corresponding record (identified by the movie reference) in the available-movies database is set to “remote”.

At step 126, the transaction started at step 119 is completed, causing the multiple presence field modifications performed in step 125 to actually affect the database in an atomic manner, not allowing any other intervening content modification by any other program or task accessing the database at the same time. The SQL statement accomplishing that action is:
COMMIT;
   This also causes exclusive access to the database to be relinquished.

At step 127, the actual file download is initiated by issuing a request for the candidate movie from the appropriate content provider system across network interface 9 (using provider locator 49). The content provider system may not respond at all or respond either by sending file data (which is written to audio/video storage 24 as it arrives), by specifying a later time for the request to be retried, or by issuing a fatal error to signal that the sought file is not available. Execution proceeds to step 128 if a fatal error occurs or if the complete file data has been received and stored. Until then, step 127 continues executing, receiving further file data and storing it or retrying its request if need be, either at the time specified by the content provider system or, if no response was received, with an increasing delay between successive attempts: the first retry is issued 30 seconds after the initial request, if there is still no response, the following retry is issued one minute later, then two minutes, and so on doubling the delay each time until it reaches 64 minutes at which point further retries are issued every 64 minutes. If a configurable maximum number (set to 50 in the presently implemented version of this invention's preferred embodiment) of no-response retries have been attempted without success, a fatal error is triggered (execution then proceeds to step 128). While actual transfer of data takes place within step 127, the speed of the download can be intentionally throttled by the STB to avoid consuming the entire network access bandwidth of the home and, for instance, share the bandwidth with other potential Internet users within the premises. To that effect, Internet Quality-of-Service (QOS) protocols understood by the house's Internet edge router may be employed to mark the file downloads as low-priority traffic. Alternatively, the download subtask may pace its acknowledgements of inbound packets to limit the average inbound data rate over multiple packets to a preset value or to a value determined empirically, for instance by observing the fluctuations of network latency as the data rate is increased or decreased.

Step 128 determines under which conditions the download operation finished. If a fatal error occurred, execution proceeds to step 129. Otherwise, the download operation completed satisfactorily and execution proceeds to step 130.

Step 129 is reached if the download failed. Any partially received file data is deleted from the audio/video storage and the presence field of the download candidate's record in the available-movies database is set to “deleted”. Execution then proceeds to step 119, to attempt to find another download candidate.

Step 130 is reached if the download succeeded. The presence field of the download candidate's record in the available-movies database is set to “local”. Execution then proceeds to step 119, to process another download candidate.

FIG. 19 shows the elements that compose provider-polling subtask 113.

First step 131 controls a loop that executes steps 133 to 136 once for each member of set of content provider systems 2 and is exited when all the known content provider systems have been polled, at which point the execution proceeds to step 132 where the subtask is put in a dormant state until a configurable amount of time (set to 3 days in the presently implemented version of this invention's preferred embodiment) has elapsed. When the task is reactivated after that dormant interval, execution proceeds to step 131 for a new polling cycle.

At step 133, a request is sent to the current content provider across network interface 9 to download an up-to-date catalog. A content provider's catalog is a list of all the movies currently available from that provider with, for each entry, the following fields (constituting a subset of the fields of available-movies database 27): movie reference, movie size, and provider locator (respectively noted, in the SQL statements below, Idₘₒᵥᵢₑ, Sizeₘₒᵥᵢₑ, and Locator_{provider}).

At step 134, available-movies database 27 is queried for a list of the movies that concern the current content provider. The following SQL query yields the relevant information (the identifier of the current provider is noted Id_{provider}):

SELECT movie_reference FROM available_movies

WHERE provider = Id_{provider};

At step 135, the list obtained at step 134 is compared to the content provider's catalog to identify entries in the catalog that are absent from the list. Those describe the movies to be added to the available-movies database. For each such entry, the following SQL statement is issued:

INSERT INTO available_movies (movie_reference, presence, size,

provider, provider_locator, in_use)
VALUES (Idₘₒᵥᵢₑ, remote, Sizeₘₒᵥᵢₑ, Id_{provider}, Locator_{provider}, false);

At step 136, the list obtained at step 134 is compared to the content provider's catalog to identify entries in the list that are absent from the catalog. Those describe the movies to be removed from the available-movies database. For each such entry, the following sequence of SQL statements is issued:

BEGIN EXCLUSIVE;

UPDATE available_movies SET presence = cancelled
WHERE movie_reference = Idₘₒᵥᵢₑ AND in_use = true;
SELECT file_locator FROM available_movies
WHERE movie_reference = Idₘₒᵥᵢₑ AND presence = local;
DELETE FROM available_movies
WHERE movie_reference = Idₘₒᵥᵢₑ
AND in_use = false AND presence <> pending;
COMMIT;”

In addition, whenever the “SELECT . . . ” statement within the above sequence returns a non-empty result (a file-locator), the corresponding movie data file is deleted from audio/video storage 24.

FIG. 20 shows the interactions among the subsystems that provide the virtual-video-rental-store. More specifically, those interactions take place between user-interface subsystem 16, viewer subsystem 17, and the following elements of virtual store management subsystem 20: audio/video storage 24, movie information database 25, user behavior history database 26, and available-movies database 27. There are no direct interactions between the user-interface subsystem or the viewer subsystem and the other elements of the virtual store management subsystem (qualifier task 28, preference list 29, and inventory manager task 30).

Viewer subsystem 17 operates under the direct control of user-interface subsystem 16 and reads digitally encoded audio and video streams from audio/video storage 24. User-interface subsystem 16 queries and occasionally updates records in available-movies database 27, queries movie information database 25, and appends records to user behavior history database 26.

The control interactions between user-interface subsystem 16 and viewer subsystem 17 are typical of that found in most VOD systems. In this embodiment, the viewer subsystem is launched by the user-interface subsystem to render a movie or a preview and is given information that allows it to locate the appropriate digitally encoded audio and video streams (within audio/video storage 24) as well as the time offset, or segment (or “track”) number where playback should start. The viewer subsystem may take over reception of some or all user input during playback in order to accept playback-specific commands such as pause, play, stop, or fast-forward/backward. When playback is finished (i.e. a “stop” command is received or the end of the audio/video stream is reached), the viewer subsystem terminates and full control of the display is returned to the user-interface subsystem.

The user-interface subsystem 16 obtains the list of movies that can be offered to the user for immediate rental by applying the following SQL query to available-movies database 27:

SELECT movie_reference, file_locator FROM available-movies

WHERE presence = local;

In addition to movie reference 45, this query also supplies file locator 48, which is needed by viewer subsystem 17 to retrieve the appropriate digitally encoded audio and video streams from audio/video storage 24.

Prior to launching viewer subsystem 17 to render a movie or a preview (designated by a specific movie reference value noted Idₘₒᵥᵢₑ herein), user-interface subsystem 16 must set in-use flag 52 via the following SQL statement:

UPDATE available_movies SET in_use = true

WHERE movie_reference = Idₘₒᵥᵢₑ;

Conversely, when the viewer subsystem terminates, the user-interface subsystem must reset the in-use flag via:

UPDATE available_movies SET in_use = false

WHERE movie_reference = Idₘₒᵥᵢₑ;

User-interface subsystem 16 obtains the list of movies that cannot be rented immediately but can be special-ordered for future rental by applying the following SQL query to the available-movies database:

SELECT movie_reference, provider_locator FROM available-movies

WHERE presence = remote OR presence = pending;

In order to display human-readable information about a movie (e.g. title, cast, rating, etc. . . . ), the user-interface subsystem obtains the corresponding record from movie information database 25 and uses joins with some ancillary identifier-to-text mapping tables (not represented in FIG. 4) within that same database to map the identifiers of interest to the proper text (e.g. mapping movie identifier 31 to the corresponding title, or an actor's identifier within cast member list 38 to the corresponding actor's name, etc. . . . ).

For each user command that corresponds to a value (noted Vₑᵥₑₙₜ herein) for event type 41 and concerning a specific movie (designated by its identifier, noted Idₘₒᵥᵢₑ herein), the User-interface subsystem appends a new record to user behavior history database 26. The SQL statement used to accomplish this depends on the event type. For a special-order, shortlist, rental, return, permanent-exclusion, or temporary-exclusion event, it is:

INSERT INTO history (event_type, movie_designation, timestamp)

VALUES (Vₑᵥₑₙₜ, Idₘₒᵥᵢₑ, CURRENT_TIMESTAMP);

For an explicit-appraisal event (with a user opinion value between −3 and +3, noted Vₐₚₚᵣₐᵢₛₐₗ), it is:

INSERT INTO history (event_type, movie_designation,

event_qualifier, timestamp)
VALUES (explicit_appraisal, Idₘₒᵥᵢₑ, Vₐₚₚᵣₐᵢₛₐₗ,
CURRENT_TIMESTAMP);

For a hold event (with a hold duration, in days, noted D_{hold}), it is:

INSERT INTO history (event_type, movie_designation,

event_qualifier, timestamp)
VALUES (hold, Idₘₒᵥᵢₑ, D_{hold}, CURRENT_TIMESTAMP);

Alternative embodiments

STB architecture

The preferred embodiment architecture shown and described above with reference to FIG. 1 and FIG. 2 characterizes the set-top box as a specialized home entertainment device dedicated to the virtual video-rental-store function. In other embodiments, the same function provided by this invention may be incorporated into a device that also provides other forms of delivery of audio/video home entertainment, in particular devices that include the essential internal electronic parts represented in FIG. 2 (namely, RAM 6, network adapter 8, processor 10, audio adapter 11, video adapter 13, and mass storage device 15). For instance, the virtual video-rental-store function may be incorporated into a digital video recorder or an Internet television set-top box; in an existing device of that kind, this incorporation would be accomplished by adding appropriate program files (22) and databases (23), reserving a portion of the available mass storage space for audio/video storage 24, and adapting the user-interface subsystem to cooperate with virtual store management subsystem 20 in accessing set of databases 23. In some cases, digital right management subprogram 19 may also need to be added to the existing viewer subsystem.

The aforementioned digital video recorder (DVR, also called personal video recorder or PVR) is a device that receives analog or digital television broadcast signals (terrestrial UHF/VHF, satellite television, or cable television) and is capable of digitally recording selected television program segments on an internal mass storage device for later playback at the convenience of the user. As such, the DVR naturally includes all the electronic components necessary for the incorporation of the virtual video-rental-store function, with the possible exception of the network adapter. Thus, the virtual video-rental-store function may be included into DVR devices readily at manufacturing time and may also be added to those already in-service via a software upgrade. For the already-built DVR devices that do not come equipped with a network adapter, the latter may be added as an external low-cost accessory, for instance plugged into a universal-serial-bus (USB) port.

The aforementioned Internet television set-top box (“iTV”) is a device that receives digitally encoded streams of television programs via the home's broadband Internet connection and plays programs to the user in near real-time (“streamed” audio/video). It may also download such programs according to explicit user requests, for later playback. The electronic components required to implement the virtual video-rental-store function are naturally present in an iTV device, with the possible exception of a mass storage device that may then need to be added.

In a further embodiment, the virtual video-rental-store function provided by this invention may be implemented within a multi-purpose personal computer (PC). A PC contains all the required electronic components. Viewer subsystem 17 is either already included in the PC operating system software or varieties thereof are readily available as third-party add-ons. In this embodiment, a suitably sized portion of the PC hard disk space would have to be set aside for audio/video storage 24. The audio playback may be output to a set of speakers directly connected to the PC and the video playback may be displayed on the PC's own video monitor, with the movie occupying the entire screen area or only a portion thereof (e.g. displayed within a rectangular “window” among the multiple ones that could be displayed on the screen by the PC operating system). Alternatively, the audio/video playback may be sent to the home entertainment center's corresponding inputs either through direct audio/video cables or relayed via any of a number of audio/video wireless transmission devices, which are available from a variety of commercial sources. User commands may be entered via the PC generic input devices (mouse and keyboard) or via a handheld remote control unit similar to that which would be used with a set-top-box.

Mobile devices

In another embodiment, a mobile audio/video entertainment device (for instance one installed in a car's passenger area, in a camping trailer, or in a recreational vehicle) may incorporate this invention. Such an embodiment requires the device to have at least occasional connectivity to the content provider systems (permanent connectivity being unlikely in a mobile environment). Although further developments in wireless technologies (e.g. broadband cellular data communications or two-way satellite Internet connectivity) may increase the amount of connectivity periods for mobile devices in the future, they are still unlikely to provide permanent high-speed data communication everywhere a mobile audio/video entertainment device could be used. In conditions where the users want to enjoy audio/video entertainment while there may not be a connection to a content provider system, for instance while in motion or while parking/camping in areas where no broadband Internet connectivity is possible, the virtual video-rental-store function provided by this invention is very attractive, compared to other means of obtaining movie entertainment (e.g. a collection of DVD media or a movie download service) that would require the users to plan ahead before a trip and explicitly manage a potentially large, evolving, stock of movies to bring along. In a mobile virtual video-rental-store scenario, the users enjoy the immediate availability of a movie selection tailored to their tastes and preferences, regardless of whether connectivity is available or not at the time of viewing. For instance, a mobile audio/video entertainment device installed in a car's passenger area could be equipped with a wireless IEEE 802.11 network adapter, allowing it to establish connectivity with the content provider systems whenever the car is parked near the user's home (assuming the home is equipped with such wireless connectivity to the Internet) or when the car is within range of a public wireless “hotspot” (i.e. an area, within a city, a university campus, a business park, or a recreation facility, etc. . . . that provides wireless connectivity to the Internet). In this example, the audio/video entertainment device's virtual video-rental-store function would provide its users with movies anywhere (e.g. on the road) and would update its stock of available movies when the car is parked at home (e.g. at night) or is within range of a hotspot.

By design, inventory manager task 30 transparently performs downloads whenever connectivity is available, so the mobile device embodiment described above is readily supported by this invention's as disclosed in FIG. 3 to 19. To support copy-protected content in this embodiment, DRM subprogram 19 has to securely store the keys and certificates required to playback the protected movies that are stocked in audio/video storage 24, since those keys and certificates may not be obtainable from the content provider systems at time of playback and would have to have been downloaded in advance. Such functionality in DRM programs has already been developed and implemented for other mobile audio/video entertainment devices (e.g. the Microsoft Windows Media® DRM 10 technology).

The implementation of the virtual video-rental-store in a portable (e.g. laptop) PC equipped with a wireless network adapter is an example that combines this alternate embodiment (mobile devices) with one of the previously discussed ones (implementation within a multipurpose personal computer) and could be a compelling feature for users of laptop PC.

In a further embodiment, a handheld mobile device, for instance a pocket computer or a handheld tablet computer, may incorporate this invention. Compared to a PC, such devices have reduced mass storage capacity and are seldom connected to the Internet, if at all. Many of these devices depend on being attached via a cable (e.g. USB) to a more powerful and better-networked machine (e.g. a PC) to exchange any large amounts of data (as would be required for a movie). In such an alternative embodiment, a host device permanently connected to the Internet (for instance a PC or the home's virtual video-rental-store set-top-box) would perform the virtual store management tasks shown on FIG. 3 (qualifier task 28 and inventory manager task 30), acting in a relay role, while the handheld mobile device would contain only those elements of the virtual video-rental-store represented on FIG. 20. On the handheld mobile device, databases 25, 26, and 27 would be replicas of the ones managed on the host device and the contents of audio/video storage 24 would be a subset (as much as can fit within the mobile mass storage capacity) of the movies held by the host device's audio/video storage (for instance the ones with the highest priority 51). During autonomous undocked operation (i.e. while not attached to the host device), the handheld mobile device's user-interface subsystem 16 would update the mobile user behavior history database to reflect user commands and would offer immediate playback capability of the movies present on the mobile audio/video storage. During docked operation (i.e. while the handheld mobile device is attached to the host device, for instance at night), the mobile user behavior history database would be replicated onto the host's user behavior history database. As the virtual store management tasks in the host device would update the host databases and audio/video storage, the corresponding changes (audio/video storage, available-movies database, and movie information database) would be in turn replicated into the docked mobile device. Thus, the handheld mobile device's virtual video-rental-store stock would be refreshed with new movie content during the docked period. The host device would also continue to run its virtual store management tasks while the mobile device is undocked, accumulating new content to be passed on to the mobile device during a later docked period. An additional field would have to be added to each row of available-movies database 27 to characterize those movies marked as “local” (per presence indicator 46) that are actually present in the mobile audio/video storage and not just in the host.

Multiple user endpoints

In another alternative embodiment, the user home may be equipped with multiple audio/video entertainment centers, for instance each of them located in a different room of the home. In such an environment, the virtual video-rental-store function can be performed by one set-top-box with multiple audio and video interfaces catering to multiple entertainment centers via direct cabling and/or some form of wireless audio/video transmission. The virtual video-rental-store function can also be performed by a plurality of set-top-boxes, each catering to one or multiple entertainment centers. In that case, the multiple set-top-boxes in the home would communicate with one another through the home's broadband local network (cabled or wireless), which would typically provide sufficient bandwidth to support reliable real time transmission of digital audio/video streams between set-top-boxes. In this context, the multiple set-top-boxes would be able to pool their audio/video storage capacity, locally storing any one movie in only one set-top-box, even though possibly more than one of them would treat it as locally stored. Thus, as it is likely that many movie preferences would be shared amongst the home's entertainment centers, the effective combined audio/video storage capacity in the home would be significantly increased and the amount of content downloaded from content provider systems would be minimized, compared to what would happen with each set-top box working in isolation.

In a further alternative embodiment, the virtual video-rental store function for multiple homes (for instance a multi-family dwelling or an apartment complex) could be concentrated into one or more high-processing-power units each with multiple audio/video outputs, thus capable of serving the entertainment needs of multiple homes without requiring each home's entertainment center to include a set-top-box. In such a context, the audio/video output could be distributed to the homes as regular television signals over coaxial cabling, as analog or digital wireless transmissions, or through any other suitable means. In this alternative embodiment, the benefits of sharing storage noted above (increased effective audio/video storage capacity and minimized downloads) would also be realized, as it would be possible for the centralized units to store a single copy of any given movie, even if that movie was treated as locally-stored for more than one home.

Content Distribution

The preferred embodiment architecture shown and described above with reference to FIG. 1 and FIG. 2 characterizes the virtual video-rental-store as dependant on point-to-point communication across the Internet network between set-top boxes and content provider systems. In other embodiments, the requests for and delivery of digital audio/video entertainment data may be carried by other means. In fact, the absence of tight coupling between the user requests through user-interface subsystem 16 and the data transfers through the network interface 9 is one of the benefits of this invention. It lets the VOD system leverage many forms of communications of diverse throughput capacities and availability characteristics, allowing the optimization of the content delivery through prioritization of downloads, spreading of the content provider systems' workload into low activity time periods, ability to pause and later resume downloads, and possible use of alternative transmission methods such as broadcast or peer-to-peer. The virtual video-rental-store function does not require the underlying communication network to provide immediate or even individualized responses to requests for audio/video content: any particular response may be deferred until a time that is convenient for the concerned content provider system or responses may be structured to satisfy similar requests from multiple separate set-top boxes at once.

For instance, the digitally encoded audio/video streams that constitute the bulk of the data downloaded may be obtained by the set-top boxes by sending requests for that data to the proper content provider system (through the Internet or possibly through an alternate, low bandwidth, communication medium such as a modem operating over a telephone line) and then receiving the data by listening over broadcast channels for the data segments corresponding to these requests. In such an alternate embodiment of the invention, the set-top box would interact with a cable (as in “cable-TV”) or satellite (as in “satellite-TV”) digital entertainment distribution system where some broadcast channels would be allocated to the distribution of virtual video-rental store movies. The content provider systems would schedule transmission of the data segments according to requests received from set-top boxes, optimizing the usage of the available transmission bandwidth by responding to multiple requests for the same movie in a single broadcast. This approach provides an entertainment delivery capability similar to the “video on demand” offerings that presently exist in some cable-TV systems, but with the following notable advantages: the number of desirable movies immediately available to each user is much greater because the selection present in each set-top box is specifically tailored to the tastes and preferences of its users compared to the generic set of movies (limited by the real-time transmission capacity of the cable system) offered by other VOD architectures; in addition, as all playback is handled locally by the set-top boxes, there are no scaling issues related to real-time transmission capacity for the content provider systems and user interactive behavior such as pausing playback, fast forwarding, or rewinding does not generate any increase of workload in those systems.

In another alternate embodiment where all the communications between the set-top boxes and the content provider systems are conducted via the Internet, some or all transmissions of digitally encoded audio/video streams would be implemented as multicast transmissions (using the Internet multicast addressing and communication protocols instead of the point-to-point ones), where each transmission from a content provider system would cater to the needs of multiple interested set-top boxes at once, thus reducing the bandwidth requirements at the content providers' end.

In yet another alternate embodiment where data communications are all conducted via the Internet, set-top-boxes would act as secondary sources for audio/video content needed by other set-top boxes. Such a peer-to-peer distribution system could use a technique known as “swarming” (exemplified by the “BitTorrent” protocol, defined on the world-wide-web at: http://www.bittorrent.com) where any set-top box that has already received a piece of a particular digitally encoded audio/video stream would be addressable by other set-top boxes in need of that same piece and thus act as an alternate source for it, instead of a content provider system. The automated nature of the virtual video-rental store function makes it particularly suited to such a swarming content distribution approach that greatly reduces the strain that large numbers of set-top boxes would otherwise cause on the content provider systems (in terms of computing workload) and their network infrastructure (in terms of communication bandwidth at the content provider's end). Contrary to more traditional client-server download architectures, swarming distribution scales extremely well with large numbers of endpoints (here, the set-top boxes): a popular content item (here, the digitally encoded audio/video stream for a popular movie) need only be transmitted once by a content provider system in the form of a multitude of separate pieces being sent to a large set of separate endpoints; then, these “seeded” endpoints download from each other the pieces they need as well as feed what they have to other endpoints that did not receive anything directly from the content provider system; eventually, each participating endpoint obtains a complete set of pieces and assembles those pieces into a full content item.

Grading methods

In other embodiments, various methods for the computation of grades, possibly using mathematical formulas different from the particular ones disclosed in the preferred embodiment description, could be used while still falling within the scope of the invention. In fact, there exist many “artificial intelligence” automated classification and/or qualification algorithms that could be adapted to the present invention's approach of mapping a history of user choices to a desirability ranking of available movies.

For example, an alternative embodiment could implement non-Bayesian qualifiers algorithms, such as those based on an approach known in the pattern-recognition branch of mathematics as “k-nearest-neighbors” (kNN) where measures of likeness between items (here, movies) are exploited to establish how akin a particular item is to a reference group by combining (e.g. adding) the measures of similarity between that item and the k most similar items (i.e. its nearest-neighbors) within the reference group, thus yielding a grade value. In such a kNN-based embodiment, the distinct characteristics of items (here, movies characteristics such as genre, cast members, keywords, age groups, etc. . . . ) would be mapped onto Cartesian coordinates in a hyperspace with as many dimensions as there are distinct characteristics. This would yield a vector in that hyperspace for each item. Using this mapping, the degree of similarity between two items would be measured as the angle between the two corresponding vectors. In that kNN-based alternative embodiment, the user behavior history would provide the reference group (a concept similar to that of the training samples constructed in the preferred embodiment) comprising all the movies appraised, implicitly or explicitly. For each movie, the corresponding vector would use multiplier factor 66 as the value (respectively positive for positive feedback and negative for negative feedback) assigned to the Cartesian coordinate corresponding to the mapped characteristic of the movie; also, any absent characteristic (e.g. absent keyword, actor, etc . . . ) in a movie would yield a zero value for the corresponding Cartesian coordinate.

Further alternative schemes for assigning preferential grades to movies (such as approaches deriving information from choices made by other users of the VOD system who are similar, in their other recorded preferences, to the user under consideration) could also be implemented while staying within the scope of the invention.

Accordingly, the reader will see that an audio/video entertainment system that includes the invention can effectively deliver video-on-demand service to its users while eliminating the bandwidth limitations, reliability and congestion issues that hinder prior art systems, without requiring its users to plan their entertainment material in advance. By unobtrusively and automatically tailoring itself to its users and constantly offering ready-to-view enticing material, this system provides viewers with immediate gratification, at any time, of their appetite for audio/video entertainment. This results in increased user satisfaction as well as increased business for the content providers (e.g. movie studios) as impulse-rental becomes a definite possibility.

In addition, by divorcing large data transfers across the communication networks from user actions, this invention allows for seamless video-on-demand services to be provided even in low-connectivity situations such as mobile or portable devices. This same property of the invention allows video-on-demand systems to leverage alternative distribution approaches such as broadcast, multicast or peer-to-peer swarming technologies.

While the above descriptions contain many specificities, these should not be construed as limitations on the scope of the invention, but as exemplifications of the embodiments thereof. Many other ramifications and variations are possible within the teachings of the invention, as exemplified by the alternative embodiments proposed above.

Moreover, the use of the generic term “movie” throughout the descriptions should not be interpreted as limiting the scope of the invention to home-video versions of theatrical movie pictures. In fact, the invention applies to any form of recorded audio/video entertainment program, for instance television shows, episodes of television serials, documentary or opinion pieces, and sports event retransmissions.

What is claimed is:

1. A client-side system for predicatively providing audio/visual content to viewers, comprising:
a means for automatically creating a viewing profile of a set of users for predicting a set of future viewing preferences based on a set of actions by the set of users;
a means for predicting a future viewing choice of at least one of the set of users as a first predicted viewing choice based on the viewing profile;
a means for selectively downloading the first predicted viewing choice as a first downloaded predicted viewing choice; and
a means for storing the first downloaded predicted viewing choice in the client-side system as a first stored predicted viewing choice for a potential later viewing.

2. The client-side system in claim 1 which further comprises:
a means for accepting a selection by a user for a viewing of the first stored predicted viewing choice as a first selected viewing choice .

3. The client-side system in claim 2 which further comprises:
a means for viewing the first selected viewing choice stored in the client-side system.

4. The client-side system in claim 2 which further comprises:
a means for automatically updating the viewing profile based on a selecting of the first selected viewing choice by the user.

5. The client-side system in claim 1 which further comprises:
a means for selecting a previously stored audio/visual file for deletion as a first selected previously stored audio/visual file; and
a means of deleting the first selected previously stored audio/visual file to make room for storing the first stored predicted viewing choice.

6. The client-side system in claim 1 which further comprises:
a means for predicting another future viewing choice of at least one of the set of users as a second predicted viewing choice based on the viewing profile;
a means for selectively downloading the second predicted viewing choice as a second downloaded predicted viewing choice; and
a means for storing the second downloaded predicted viewing choice in the client-side system as a second stored predicted viewing choice for a potential later viewing.

7. The client-side system in claim 6 which further comprises:
a means for accepting a selection by a user for a viewing of the second stored predicted viewing choice as a second selected viewing choice; and
a means for viewing the second selected viewing choice stored in the client-side system.

8. The client-side system in claim 1 wherein:
the client-side system is a part of a set top box.

9. The client side system in claim 1 wherein:
the client side system is a part of a home entertainment system.

10. The client-side system in claim 1 wherein:
the client-side system is included within a personal computer.

11. A method of providing a audio/visual content for immediate viewing:
predicting a set of future viewing preferences as a set of predicted viewing choices based on a history of past viewing;
downloading a one of the set of predicted viewing choices speculatively as a downloaded predicted viewing choice;
storing the downloaded predicted viewing choice as a stored predicted viewing choice; and
offering the stored predicted viewing choice to a user for viewing.

12. The method in claim 11 which further comprises:
accepting a selection of the stored predicted viewing choice by the user as a selected viewing choice;
providing the selected viewing choice to the user for viewing; and
charging a rental fee for the providing the selected viewing choice to the user for viewing.

13. The method in claim 12 which further comprises:
rebating the rental fee if the user is dissatisfied with the selected viewing choice.

14. The method in claim 12 which further comprises:
utilizing a fact that the user is dissatisfied with the selected viewing choice as negative rating information in the history of past viewing.

15. The method in claim 12 which further comprises:
utilizing a fact that the user selects the selected viewing choices as positive rating information in the history or past viewing.

16. The method in claim 11 wherein:
the stored predicted viewing choice is stored locally to the user.

17. The method in claim 11 wherein:
the user is provided a mechanism for impulse viewing purchases.

18. The method in claim 11 wherein:
the downloading utilizes peer-to-peer swarming to download portions of the downloaded predicted viewing choice from a plurality of remote sources.

19. The method in claim 18 which further comprises:
providing a remote peer system with a portion of the stored predicted viewing choice.

20. A method of providing an audio/visual content for immediate viewing:
providing a system for a user that provides for:
predicting a set of future viewing preferences as a set of predicted viewing choices based on a history of past viewing;
downloading a one of the set of predicted viewing choices speculatively as a downloaded predicted viewing choice;
storing the downloaded predicted viewing choice as a stored predicted viewing choice; and
offering the stored predicted viewing choice to the user for viewing.
